(19) United States
(12) Patent Application Publication
(10) Pub. No.: US 2026/0080432 A1
(43) Pub. Date: Mar. 19, 2026

(54) ARTIFICIAL INTELLIGENCE-BASED MARKETING CAMPAIGN ENHANCEMENT SYSTEM AND METHOD

(71) Applicant: Attentive Mobile, Inc., Hoboken, NJ (US)

(72) Inventors: Eric Miao, Hoboken, NJ (US); Amit Jhawar, Hoboken, NJ (US); Jesse Greenberg, Hoboken, NJ (US); Nakul Narayan, Hoboken, NJ (US)

(73) Assignee: Attentive Mobile, Inc., Hoboken, NJ (US)

(21) Appl. No.: 19/328,836

(22) Filed: Sep. 15, 2025

Related U.S. Application Data
(60) Provisional application No. 63/695,629, filed on Sep. 17, 2024.

(51) Int. Cl. G06Q 30/0242; G06Q 30/018

(52) U.S. Cl. CPC G06Q 30/0244; G06Q 30/018

(57) ABSTRACT

A system for enhancing targeted marketing campaigns utilizes an artificial intelligence module to automatically identify additional individuals to include in an audience or to exclude from the audience to optimize the campaign's total revenue or return on investment (ROI) or provide a balance between revenue and ROI. The artificial intelligence module is also able to modify the content of the messages to more accurately reflect a brand voice and to determine optimal times to send messages for the campaign.

### CROSS REFERENCES TO RELATED APPLICATIONS

The present application claims the benefit of and priority to U.S. Provisional Ser. No. 63/695,629, filed Sep. 17, 2024. The above listed application is incorporated herein by reference in its entirety.

### BACKGROUND OF THE INVENTION

### 1. Field of the Invention

The present invention relates to systems and methods for enhancing directed campaigns and, more specifically, to artificial intelligence-enhanced marketing campaigns.

### 2. Description of the Prior Art

It is generally known in the prior art to provide online platforms for managing marketing campaigns.

Prior art patent documents include the following:

U.S. Pat. No. 12,067,362 for Computer implemented methods for the automated analysis or use of data, including use of a large language model by inventors William Tunstall-Pedoe et al., filed Apr. 17, 2023, and issued Aug. 20, 2024, discloses methods, such as a method of interacting with a large language model (LLM), including the step of a processing system using a structured, machine-readable representation of data that conforms to a machine-readable language, such as a universal language, to provide new context data for the LLM, in order to improve the output, such as continuation text output, generated by the LLM in response to a prompt; and such as a method of interacting with a LLM, including the step of providing continuation data generated by the LLM to a processing system that uses a structured, machine-readable representation of data that conforms to a machine-readable language, such as a universal language, in which the processing system is configured to analyze the continuation output generated by the LLM in response to a prompt to enable an improved version of that continuation output to be provided to a user. Related computer systems are provided.

U.S. Pat. No. 12,147,513 for Dynamic evaluation of language model prompts for model selection and output validation and methods and systems of the same by inventors Payal Jain et al., filed Apr. 11, 2024, and issued Nov. 19, 2024, discloses systems and methods relating to a model validation platform that enables dynamic validation of a user's prompt for a large language model (LLM) in order to evaluate the validity of the prompt and the suitability of a large language model for processing the prompt. For example, the platform enables an estimation of the resource allocation associated with processing the prompt with a given LLM, as well as a modification of the prompt, prior to the processing the prompt with the selected LLM. The platform can further validate the output prior to transmitting the output to a server system for display to the user. By doing so, the platform enables dynamic evaluation of a request to execute an LLM, as well as evaluation of resulting outputs, for accuracy and efficiency improvements in data processing or software development pipelines.

US Patent Pub. No. 2024/0296275 for Guardrails for efficient processing and error prevention in generating suggested messages by inventors Caleb Whitmore et al., filed Mar. 3, 2023, and published Sep. 5, 2024, discloses systems and methods for using a generative artificial intelligence (AI) model to generate a suggested draft reply to a selected message. A message generation system and method are described that use guardrails that prevent unnecessary AI model processing and accidental sending of an AI model-generated draft. In some examples, draft reply-generation is limited to a subset of messages (e.g., focused, non-confidential) and triggering of the draft reply generation is performed only after user interaction criteria are satisfied. In some examples, a confirmation message is presented when the draft reply is attempted to be sent with no changes or quickly after the draft is generated. For instance, the guardrails limit the number of times the AI model is invoked to generate suggested replies and further prevents users from accidentally sending drafts generated from the AI model.

U.S. Pat. No. 11,875,130 for Confidence generation for managing a generative artificial intelligence model by inventors Dusan Bosnjakovic et al., filed Jul. 25, 2023, and issued Jan. 16, 2024, discloses systems and methods for managing a generative artificial intelligence (AI) model. Managing the generative AI model may include training or tuning the generative AI model before use or managing the operation of the generative AI model during use. Training or tuning a generative AI model typically requires manual review of outputs from the model based on the queries provided to the model to reduce hallucinations generated by the generative AI model. Once the model is in use, though, hallucinations still occur. Use of a confidence (whose generation is described herein) to train or tune the generative AI model and/or manage operation of the model reduces hallucinations, and thus improves performance, of the generative AI model.

US Patent Pub. No. 2021/0383437 for Systems and methods for processing message exchanges using artificial intelligence by inventor Brigham, filed Jun. 18, 2021, and published Dec. 9, 2021, discloses systems and methods for processing automated message exchanges using artificial intelligence. In some embodiments, a message is generated by populating variable fields within a message template with corresponding data from a knowledge set and/or a lead data set. Lead data is the data known about the intended recipient of the message, whereas the knowledge set is contextual knowledge useful for the artificial intelligence. Once the message has been generated, the system waits for a response from the lead. Once the response is received, the AI algorithms may categorize the response and generate a corresponding confidence value for the categorization. The categorization and confidence level are utilized to determine which subsequent action the system takes. The actions consist of sending a follow-up message, a subsequent message in the series, requesting user input, or discontinuing messaging.

US Patent Pub. No. 2024/0037607 for Method and system for exemplary campaign message management by inventors Hadji et al., filed Sep. 26, 2023, and published Feb. 1, 2024, discloses methods and systems for improved and efficient campaign message management. Via an automated process, the system can generate, classify and sort a browsable collection of diverse, high-performing campaign messages, e.g., emails and SMS messages. Such messages can prompt a prospective campaign generator to create quality content for his/her own campaigns. Furthermore, varied and relevant exemplary campaigns can be shown to different users in response to his/her unique needs or expressed interests.

US Patent Pub. No. 2021/0233097 for System and method for text-based delivery of sales promotions by inventors Doumar et al., filed Apr. 13, 2021, and published Jul. 29, 2021, discloses a system and method for obtaining sales promotions via a text-messaging based interaction. The system comprises a call-to-action link that reduces the number of steps needed to obtain a sales promotion via a website. The call-to-action link triggers a prepopulated text message on a user's mobile device, whereby the user needs to only press send, and receive the sales promotion text message in return. The returned text message may provide the sales promotion in a variety of ways, such as a scannable bar code or QR code, a hypertext or URL link, an alphanumeric text, or other medium send-able via messaging services and usable by business establishments.

US Patent Pub. No. 2023/0259957 for Guest messaging platform by inventors Mulay et al., filed Feb. 11, 2022, and published Aug. 17, 2023, discloses a platform for customer and prospective customer messaging. The platform generally coordinates message audience selection, message timing, and message content for delivery on any of a variety of communication channels (e.g., email, text message, push notification) for messages from marketing tenants and operational tenants to ensure a coordinated customer experience.

US Patent Pub. No. 2008/0162399 for Consumer marketing platform by inventors Tam et al., filed Dec. 31, 2006 and published Jul. 3, 2008, discloses a system and method for consumer marketing. A system is illustrated that includes a receiver residing on a server to receive a rules set, a generator residing on the server to generate a rules model, a transmitter residing on the server to transmit a solicitation of data from a customer regarding good and services, and a second generator to create an updated rules model using an Artificial Intelligence (AI) algorithm, or some combination of AI algorithms. In some embodiments, a method is illustrated as including receiving a rules set, generating a rules model, soliciting data from a customer regarding good and services, and creating an updated rules model using an AI algorithm. Further, the method may include soliciting data using a communication process the process selected from a group of processes consisting of discussion boards, email, real-time chat, and a Short Message Service (SMS) message.

U.S. Pat. No. 11,985,571 for Predicting user interaction with communications by inventors Jaini et al., filed Sep. 29, 2021, and issued May 14, 2024, discloses a machine learning model trained using annotated communications data. Each communication (e.g., a short messaging system (SMS) message or email) is annotated with a measure of user interaction. The machine learning model is thus trained to predict a measure of user interaction for future communications. Before sending future communications, at least a portion of the communication is provided to the trained machine learning model to predict the expected measure of user interaction with the communication. In response to the prediction, the sender of the communication may alter the communication. The system may automatically send the communication if the predicted measure of user interaction exceeds a predetermined threshold and only prompt the user if the predicted measure of user interaction does not exceed the predetermined threshold.

U.S. Pat. No. 11,966,909 for Text messaging service based commerce system by inventors Foster et al., filed Dec. 16, 2021 and issued Apr. 23, 2024, discloses a computing device providing enhancement of the capabilities of text messaging applications that execute on user devices. The computing device includes a processor that receives a text message via a network from a user device, the text message including a character representation of a product bundle of a merchant. The processor determines bundle data for the product bundle by referencing a database using the character representation. The processor provides one or more text messages via the network to the user device with transaction data including the bundle data, payment data, and shipping data. The processor receives a text message via the network from the user device confirming the transaction data. The user may use text commands presented by the computing device or natural language conversation in the text messages to the computing device to modify the transaction data and perform other ecommerce actions.

U.S. Pat. No. 11,810,157 for Method and system for Exemplary campaign message management by inventors Hadji et al., filed Oct. 27, 2022, and issued Nov. 7, 2023, discloses methods and systems for improved and efficient campaign message management. Via an automated process, the system can generate, classify and sort a browsable collection of diverse, high-performing campaign messages, e.g., emails and SMS messages. Such messages can prompt a prospective campaign generator to create quality content for his/her own campaigns. Furthermore, varied and relevant exemplary campaigns can be shown to different users in response to his/her unique needs or expressed interests.

U.S. Pat. No. 11,403,666 for System and method for advertisement campaign tracking and management utilizing near-field communications by inventor Doumar, filed Jul. 16, 2020, and issued Aug. 2, 2022, discloses a system and methods for advertisement campaign tracking and management using near-field communications. The system is a cloud-based network containing an advertisement campaign database, a redirection server, a short message service server, near-field communication devices, a mobile application, user mobile and compute devices. Taken together or in part, said system optimizes advertising campaigns across multiple platforms, provides strong analytics for all advertising types while allowing users to engage with advertising quickly and easily through various call to action types.

U.S. Pat. No. 11,109,083 for Utilizing a deep generative model with task embedding for personalized targeting of digital content through multiple channels across client devices by inventors Saini et al., filed Jan. 25, 2019, and issued Aug. 31, 2021, discloses systems, methods, and non-transitory computer readable media for training and utilizing a generative machine learning model to select one or more treatments for a client device from a set of treatments based on digital characteristics corresponding to the client device. In particular, the disclosed systems can train and apply a variational autoencoder with a task embedding layer that generates estimated effects for treatment combinations. For example, the disclosed systems receive, as input, digital characteristics corresponding to the client device and various treatment combinations. The disclosed systems apply the trained generative machine learning model with the task embedding layer to the digital characteristics to generate effect estimations for the various treatment combinations. Based on the effect estimations for the treatment combinations, the disclosed systems select one or more treatments to provide to the client device.

U.S. Pat. No. 11,038,976 for Utilizing a recommendation system approach to determine electronic communication send times by inventors Liu et al., filed Sep. 9, 2019, and issued Jun. 15, 2021, discloses systems, methods, and non-transitory computer readable media for determining send times for distributing digital content to client devices utilizing a recommendation system approach. For example, the disclosed systems can utilize a recommendation system model such as a matrix factorization model, a factorization machine model, and/or a neural network to implement collaborative filtering to generate predicted response rates for particular candidate send times. Based on the predicted response rates indicating likelihoods of receiving responses for particular send times, the disclosed system can generate a distribution schedule to provide electronic communications at one or more of the send times.

U.S. Pat. No. 11,010,555 for Systems and methods for automated question response by inventors Terry et al., filed Sep. 12, 2018, and issued May 18, 2021, discloses systems and methods for natural language processing and classification. In some embodiments, the systems and methods include a communication editor dashboard which receives the message, performs natural language processing to divide the message into component parts. The system displays the message in a first pane with each of the component parts overlaid with a different color, and displaying in a second pane the insights, the confidence scores associated with each insight, the sentiment and the actions. In another embodiment, the systems and methods include combining outputs from multiple machine learned AI models into a unified output. In another embodiment, the systems and methods include responding to simple question using natural language processing.

US Patent Pub. No. 2024/0029103 for AI-Based Advertisement Prediction and Optimization Using Content Cube Methodology by inventors Myers et al., filed Apr. 26, 2023, and published Jan. 25, 2024, discloses a Multidimensional Framework and virtualized data repository ('Content Cube') and AI-based SaaS Workflow Platform for the intelligent prediction of one or multiple digital advertising designs, which are curated and hyper-localized according to (1) the attributes and features of target customers segmented firstly by their underlying personalities, interests, and behaviors at a given stage in their customer journey and secondly; (2) how such generalized personas are manifest as situationally specific behavior triggers and motivational drivers relative to the unique context and needs of the Client's ad campaign mandate (i.e., brand and marketing mix, content calendar, ad campaign goals and KPIs, choice of medium/media channel, client budget, etc.) against which the performance of the Creative may be measured in real-time and modified dynamically as needed.

US Patent Pub. No. 2015/0142586 for Methods and systems for systemizing a brand voice by inventor Schulz, filed Jun. 18, 2014, and published May 21, 2015, discloses a computer-implemented method for systemizing a brand voice. The computer implemented method includes the steps of defining a framework having one or more of writing styles, identifying one or more brand voice characteristics associated with each of the one or more writing styles, assigning an optimum quantitative value to each brand voice characteristic for each writing style based on one or more communication factors, and outputting the optimum quantitative value of each brand voice characteristic for a selected one or more writing styles. The method also includes the steps of receiving written material in a brand voice software application, analyzing the written material to determine a quantitative value for identified brand voice characteristics in the written material, comparing the determined quantitative value to a target quantitative value of the identified brand voice characteristics, altering the written material based on the comparison, and outputting the altered written material.

U.S. Pat. No. 11,985,270 for System and methods for adaptive campaign management and predictive customer engagement utilizing a customer data platform by inventors Koul et al., filed Mar. 6, 2023, and issued May 14, 2024, discloses a system and method providing adaptive campaign management and customer engagement predictions utilizing a customer data platform comprising an data ingestion module, an analytics module, and a unified customer database. Furthermore, the system and method ingest a plurality of disparate information related to a customer from various information sources such as enterprise specific customer records, social media data and metadata, web app data and metadata, and mobile device app data and metadata, transforms the ingested data into a standard data format, and correlates the transformed data with existing customer information to form a unified customer profile. The system uses machine learning for predictions and maintenance of customer profiles, and continuously and automatically updates the machine learning models over time. A collection of unified customer data profiles may represent a unified knowledge base of customer information that can be accessed by a plurality of enterprises for call campaign management.

U.S. Pat. No. 11,983,732 for System and method for developing a growth strategy by inventor Shah, filed Nov. 3, 2022, and issued May 14, 2024, discloses a method comprising: analyzing a historical data of an entity over a past period comprising a past transaction and a past revenue to develop a buyer persona of a customer in order to identify ideal prospects; selling a target revenue goal for the entity; generating revenue economics using conversion metrics from the target revenue goal as an input; generating a marketing budget working backward from the revenue economics; and generating a marketing plan for a future period that is based on the marketing budget; wherein the method comprises conducting a Strengths, Weaknesses, Opportunities, and Threats (SWOT) analysis to take an inventory of current situation of the entity and to identify target market segments by generating the opportunities that are in alignment with the strengths of the entity; and wherein the method is for generating a growth master plan for the future period.

U.S. Pat. No. 11,159,680 for Response quality index for service sessions by inventors Horne et al., filed Aug. 11, 2020, and issued Oct. 26, 2021, discloses techniques for analyzing communications sent during a service session to provide (e.g., customer) service on a social media channel, the analysis to determine a quality of service provided during the session. Natural language processing, lexical analysis, pattern matching, or other types of analysis may be used to determine an empathy factor and a conversational factor for communications between a service representative (SR) and a user during a session. The factors may be combined with other factors, such as a timely acknowledgement factor and a timely resolution factor, to generate a response quality index (RQI) for the session. Based on the RQI, feedback information may be generated and sent to the SR. In some implementations, the communications may be analyzed and feedback information sent to the SR in real time during the session, to dynamically improve service quality.

U.S. Pat. No. 10,242,380 for Systems and methods for determining an agility rating indicating a responsiveness of an author to recommended aspects for future content, actions, or behavior by inventor Hamedi, filed Sep. 7, 2015, and issued Mar. 26, 2019, discloses a method including determining a recommended aspect for future content, action, or behavior. The recommended aspect is determined at least in part based on activity data that indicates aspects of other content authored by or interacted with by a plurality of authors in a social network prior to receipt of the selection. The method also includes providing the recommended aspect for the future content, action, or behavior for a unique author in the social network. The method also includes determining whether the unique author posted the future content, action, or behavior with the recommended aspect in the at least one social network. The method also includes determining, based at least in part on the determination of whether the unique author posted the future content, action, or behavior with the recommended aspect, an agility rating that indicates a responsiveness of the unique author to the recommended aspect.

U.S. Pat. No. 9,473,446 for Personalized delivery time optimization by inventors Vijay et al., filed Jun. 30, 2014, and issued Oct. 18, 2016, discloses techniques for optimizing a delivery time for the delivery of messages. According to various embodiments, a system determines, for each of a plurality of time intervals, a likelihood of a particular member of an online social network service performing a particular member user action on a particular message content item during the corresponding time interval. The plurality of time intervals is then ranked, based on the determined likelihoods corresponding to the plurality of time intervals. Thereafter, a particular time interval is identified from among the plurality of time intervals that is associated with a highest ranking. The particular time interval is then classified as an optimum personalized message delivery time for the particular member.

### SUMMARY OF THE INVENTION

The present invention relates to systems and methods for enhancing directed campaigns and, more specifically, to artificial intelligence-enhanced marketing campaigns.

It is an object of this invention to provide a system for leveraging artificial intelligence to boost revenue and/or return on investment for a marketing campaign via improved audience targeting, improved brand voice integration, and other tools.

In one embodiment, the present invention is directed to a system for enhancing a targeted marketing campaign, including at least one server platform, including at least one computer processor and a memory, in network communication with at least one user device, and at least one quality checking large language model (LLM), wherein the at least one server platform includes an artificial intelligence (AI) module, wherein the AI module is operable to automatically generate at least one marketing campaign based on input from the at least one user device, wherein the at least one marketing campaign includes a target audience, optimal send time, and brand voice matching, wherein the at least one quality checking LLM is operable to review the at least one marketing campaign via natural language processing for accuracy of the target audience, the optimal send time, and the brand voice matching relative to the input from the at least one user device, and wherein the at least one quality checking LLM is operable to provide a quality score for the at least one marketing campaign.

In another embodiment, the present invention is directed to a method for enhancing a targeted marketing campaign, including providing at least one server platform, including at least one computer processor and a memory, in network communication with at least one user device, providing at least one quality checking large language model (LLM), integrating an artificial intelligence (AI) module into the at least one server platform, the at least one server platform receiving an input from the at least one user device, generating by the AI module at least one marketing campaign based on the input from the at least one user device, wherein the at least one marketing campaign includes a target audience, optimal send time, and brand voice matching, reviewing by the at least one quality checking LLM the at least one marketing campaign via natural language processing for accuracy of the target audience, the optimal send time, and the brand voice matching relative to the input from the at least one user device, and generating by the at least one quality checking LLM a quality score for the at least one marketing campaign.

In yet another embodiment, the present invention is directed to a system for enhancing a targeted marketing campaign, including at least one server platform, including at least one computer processor and a memory, in network communication with at least one user device, at least one quality checking large language model (LLM), and at least one artificial intelligence (AI) concierge, wherein the at least one server platform includes an AI module, wherein the AI module is operable to automatically generate at least one marketing campaign based on input from the at least one user device, wherein the at least one marketing campaign includes a target audience, optimal send time, and a brand voice, wherein the at least one quality checking LLM is operable to review the at least one marketing campaign via natural language processing for accuracy of the target audience, the optimal send time, and the brand voice relative the input from the at least one user device, and wherein the at least one AI concierge is operable to automatically respond to feedback received from the at least one user device about the at least one marketing campaign.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a graphical user interface for generating and modifying a targeted marketing campaign according to one embodiment of the present invention.

FIG. 2 illustrates a graphical user interface including a drawer for boosting an audience for a targeted marketing campaign according to one embodiment of the present invention.

FIG. 3 illustrates a graphical user interface including an audience boost function with an audience segment selection tool according to one embodiment of the present invention.

FIG. 4 illustrates a graphical user interface including an audience boost function with an audience segment selection and exclusion tool according to one embodiment of the present invention.

FIG. 5 illustrates a graphical user interface including an audience boost function with an audience segment selection and exclusion tool in the process of generating an optimized audience according to one embodiment of the present invention.

FIG. 6 illustrates a graphical user interface including an audience boost function with an audience segment selection and exclusion tool with a suggested optimized audience according to one embodiment of the present invention.

FIG. 7 illustrates a graphical user interface including an audience boost function with an audience segment selection and exclusion tool with a plurality of options for optimizing an audience according to one embodiment of the present invention.

FIG. 8 illustrates a schematic diagram for determining how to execute a marketing strategy according to one embodiment of the present invention.

FIG. 9 is a schematic diagram of a marketing campaign enhancement system according to one embodiment of the present invention.

FIG. 10 is a schematic diagram of a computer system of the present invention.

### DETAILED DESCRIPTION

The present invention is generally directed to systems and methods for enhancing directed campaigns and, more specifically, to artificial intelligence-enhanced marketing campaigns.

In one embodiment, the present invention is directed to a system for enhancing a targeted marketing campaign, including at least one server platform, including at least one computer processor and a memory, in network communication with at least one user device, and at least one quality checking large language model (LLM), wherein the at least one server platform includes an artificial intelligence (AI) module, wherein the AI module is operable to automatically generate at least one marketing campaign based on input from the at least one user device, wherein the at least one marketing campaign includes a target audience, optimal send time, and brand voice matching, wherein the at least one quality checking LLM is operable to review the at least one marketing campaign via natural language processing for accuracy of the target audience, the optimal send time, and the brand voice matching relative to the input from the at least one user device, and wherein the at least one quality checking LLM is operable to provide a quality score for the at least one marketing campaign.

In another embodiment, the present invention is directed to a method for enhancing a targeted marketing campaign, including providing at least one server platform, including at least one computer processor and a memory, in network communication with at least one user device, providing at least one quality checking large language model (LLM), integrating an artificial intelligence (AI) module into the at least one server platform, the at least one server platform receiving an input from the at least one user device, generating by the AI module at least one marketing campaign based on the input from the at least one user device, wherein the at least one marketing campaign includes a target audience, optimal send time, and brand voice matching, reviewing by the at least one quality checking LLM the at least one marketing campaign via natural language processing for accuracy of the target audience, the optimal send time, and the brand voice matching relative to the input from the at least one user device, and generating by the at least one quality checking LLM a quality score for the at least one marketing campaign.

In yet another embodiment, the present invention is directed to a system for enhancing a targeted marketing campaign, including at least one server platform, including at least one computer processor and a memory, in network communication with at least one user device, at least one quality checking large language model (LLM), and at least one artificial intelligence (AI) concierge, wherein the at least one server platform includes an AI module, wherein the AI module is operable to automatically generate at least one marketing campaign based on input from the at least one user device, wherein the at least one marketing campaign includes a target audience, optimal send time, and a brand voice, wherein the at least one quality checking LLM is operable to review the at least one marketing campaign via natural language processing for accuracy of the target audience, the optimal send time, and the brand voice relative the input from the at least one user device, and wherein the at least one AI concierge is operable to automatically respond to feedback received from the at least one user device about the at least one marketing campaign.

In the current economic environment, it is harder than ever to capture a customer's attention. The low or negative return on investment (ROI) from generalized ad campaigns has led to increased focus on targeted advertising, especially given the wider breadth of consumer data available on which to base the targeting. However, the wealth of consumer data does not necessarily mean that selection of target audiences for a marketing campaign is simple. Such audience selection represents a key challenge for targeted advertising, especially given the struggle between maximizing revenue (which will typically involve a wider defined audience) and optimizing for ROI (which will typically involve a more selective audience).

What is needed is a system leveraging artificial intelligence (AI) and machine learning (ML) to automatically optimize a target audience while providing transparency for exactly what modifications are being made to optimize the target audience and allowing for optimization for different variables, such as return on investment (ROI), revenue, opt-out rate, clickthrough rate (CTR), conversion rate (CVR), and/or other variables.

An additional challenge for targeted advertising campaigns is reflecting the intended vision and voice of the brand in a way that is inviting and likely to lead to clickthrough for the target audience, rather than putting off the target audience. In particular, the challenge often lies in finding an intersection between performant language and a brand voice of the company/customer in a way that will maximally increase revenue or otherwise satisfy the goals of the marketing campaign. The reliability of artificial intelligence for constructing or conveying a brand voice has led to hesitancy in the past, as cost savings as a result of utilizing AI/ML are quickly lost if the AI/ML creates egregious content or hallucinates to create nonsensical or obviously wrong content that turns off the target audience.

What is needed is a system that leverages AI/ML but includes heuristic and/or AI-evaluated guardrails to produce content that does not violate brand guidelines and that is unlikely to hallucinate to create nonsensical content. Furthermore, there is a need for both the content generated by the AI/ML and the guardrails to be based on previous campaigns or communications by each particular company (and/or across different companies) via the use of historical data. Thereby, this platform needs to produce on-target messages that align with a brand voice and identity for the target audience.

A further challenge of targeted advertising is choosing the right time to message a target audience. Timing is often the difference between whether individual members of a target audience click through the marketing material or not, so optimizing send time for messages in terms of time of day, day of the week, time of month, or other times is key for optimizing the effect of a marketing campaign. While campaign marketing systems often allow for selecting when messages are sent, these platforms do not generally provide insight for optimizing those times based on known factors of the target audience.

Thus, a system is also needed to utilize AI/ML to determine optimal send times for a marketing campaign based on the specific target audience in question and/or based on the content of the marketing campaign itself.

The present invention is operable to provide AI optimization for all of send time, target audience selection, and content generation with brand voice matching for optimizing revenue or ROI, or a balanced strategy of the two (or other parameters, such as clickthrough rate). The present invention provides statistical analysis regarding projected impact of optimizing send time, target audience, changed content, and retrospective attribution of impact on revenue generation or changes to ROI as a result of the optimization performed by the present invention. Therefore, the present invention allows for assessment of the impact of the AI/ML tools to determine whether and how to use the tools in the future.

Referring now to the drawings in general, the illustrations are for the purpose of describing one or more preferred embodiments of the invention and are not intended to limit the invention thereto.

The server platform of the present invention includes one or more servers connected to one or more databases operable to receive inputs from one or more user devices (e.g., smartphones, computers, tablets, etc.) via graphical user interfaces (GUIs) on the one or more user devices and is operable to transmit notifications, messages, and information to the one or more user devices over a network connection. The present invention is able to operate through a web-based interface or through a native application. The server platform includes an artificial intelligence (AI) module configured to provide optimization for a targeted marketing campaign as described below.

The platform is able to be used both by marketing firms on behalf of multiple different clients, or directly by a company seeking to manage its own campaigns for its own products. The artificial intelligence-boosted systems of the present invention are operable to be combined with existing marketing platforms described in the prior art, including, but not limited to, those described in U.S. Pat. Nos. 11,170,380, 11,553,074, 11,416,897, 11,416,887, 11,935,068, and 11,676,155 and U.S. Patent Pub. No. 2023/0259949, each of which is incorporated herein by reference in its entirety.

### Auto-Audience

The auto-audience tool of the present invention provides for an AI/ML-based adjustment to a target audience for a marketing campaign of a user. The platform is able to suggest both increases (to find additional revenue) or decreases (to reduce cost) of the target audience in order to optimize for revenue or ROI, or a mixed strategy for the two. In one embodiment, the target audience optimization is based on an ideal target audience model that focuses primarily on clicks, purchase data, opt-out rate, and/or site visits for each of the consumers in the identified target audience, especially when such clicks, site visits, and purchase data correspond to the user's own site and products or similar sites and products. However, the model does not solely optimize for clickthrough rate, as clicks that do not translate into purchases are less helpful for a target audience, so clickthrough rate is preferably combined with at least one other purchase or engagement metric according to the model. Preferably, the model is able to predict numerous propensities about individual subscribers, such as likelihood to purchase, likelihood to click, and opt-out probability, and is further able to sort subscribers by a weighted combination of these elements to optimize for many different objectives of a company's campaigns. For example, in one embodiment, the model takes into account 30-day, 60-day, and/or 90-day click conditions for each contact in combination with a 30-day, 60-day, and/or 90-day subscription or purchase condition. This model contrasts with many prior art models that focus on revenue maximization above all else. For different optimization constraints, however, this model is able to be modified. For example, in one embodiment, for an ROI optimizing model, the threshold of clickthrough potential or purchase likelihood is higher to select a contact for inclusion in the model, while, for a revenue-maximizing model, the threshold is lower.

In one embodiment, the platform is operable to optimize for lifetime value (LTV), or the total amount of revenue expected to be gained from a consumer over the entire course of their relationship with the company. In one embodiment, the machine learning module determines LTV for particular contacts based on historical data concerning each contact's previous interactions with the company, with other companies, and/or additional data concerning the contact. In one embodiment, the machine learning module automatically determines an opt-out propensity threshold for one or more contacts, wherein the opt-out propensity threshold indicates a maximum frequency of messages likely to be able to be sent to a contact or subscriber before opt-out is caused. Therefore, the system is operable to message between a minimum frequency needed to drive revenue from the contact, as determined by the machine learning module, and the opt-out threshold frequency, so as to maximize LTV for each contact.

In one embodiment, according to the model, contacts are automatically excluded from the AI-optimized target audience based on specific criteria. For example, in one embodiment, contacts are automatically excluded if the contact is designated as having never purchased and never clicked but joined over 180 days prior. In one embodiment, contacts are excluded based on historical opt-out rate and/or predicted opt-out likelihood. More generally, in one embodiment, a heuristic is used to exclude contacts with a low propensity to purchase or based on some other predicted value.

In one embodiment, additional constraints are able to be placed on the AI-optimization model, including that the model is only able to increase or only able to decrease the number of contacts or is unable to remove contacts within a subset of the target audience. In one embodiment, selections to only allow the AI-optimization model to increase or decrease the number of contacts are performed by click selection of one or more check boxes by a user device. In one embodiment, the platform prohibits unchecking both a box to allow additional contacts and a box to allow removal of contacts at the same time (as the model must necessarily do at least one of these two things). In one embodiment, selection to only allow additions or removals is saved as a sticky default preference for future optimization of different campaigns or for different segments, or a prompt is generated requesting input as to whether to set these settings as a default preference in the future. In one embodiment, rather than removing low propensity contacts within a segment or audience, the platform receives an input to instead identify and not remove these contacts. By identifying the low propensity contacts, the platform is operable to automatically assign those contacts to a new, separate segment (e.g., to custom design messages for the low-propensity group) or flag them in a generated spreadsheet for manual review by a user. In one embodiment, the platform allows for both removal and identification of low propensity contacts, such that those contacts are removed from the segment but are automatically added to a separate segment and/or flagged in a generated spreadsheet. Furthermore, identifying those contacts allows users to run a campaign with the users included to note what the net decrease in cost and revenue would have been for removing those contacts as suggested, as a test run for the platform's validity, thereby building confidence in the efficacy of the platform.

In one embodiment, the AI-optimization model includes a volume change limitation by default, which prevents the AI-optimization model from changing the original target audience by greater than 10% (i.e., cannot increase or decrease the target audience size by more than 10%), but one of ordinary skill in the art will understand that the specific limit is able to be varied according to the present invention. Furthermore, in one embodiment, the platform is operable to receive a selection to lift or adjust the 10% limit. In one embodiment, if greater than 10% would, in the absence of the volume change limitation, be qualified for exclusion from the target audience, the 10% selected to exclude is randomly chosen. This means that the model does not necessarily exclude the 10% that are less likely to generate revenue or based on any arbitrary criteria (e.g., number order, alphabetically, etc.), but instead chooses which 10% to exclude without explicit criteria. This is helpful because it prevents the same contacts from being excluded in all campaigns and thereby prevents the platform from limiting the degree to which certain contacts are able to show engaged behavior. Alternatively, in another embodiment, the 10% excluded is chosen based on conversion likelihood (or other statistics) or criteria such as number order or alphabetical order of the contacts.

In one embodiment, the platform is operable to receive a budget amount for the marketing campaign. The budget is operable to act as a limitation for the degree of revenue maximization, such that a revenue maximizing model ceases to add additional contacts to the target audience, where such addition would increase the total budget for the campaign over the provided budget amount.

In one embodiment, the platform of the present invention is operable to receive a plain text description of a campaign description, campaign goals, a target audience, products or services being sold, and/or other information and process this description (e.g., through natural-language processing) to obtain insight regarding the target audience of the campaign. The platform is able to receive a list of a plurality of contacts for an existing target audience and/or one or more segment subsets of the target audience. In one embodiment, the platform is also able to receive a list of excluded contacts for a target audience (i.e., a list of contacts that should not be added to the target audience) or a list of excluded contacts for a particular segment of the target audience (i.e., a list of contacts that should not be added to the segment of the target audience). Upon user input, the platform is operable to optimize the target audience as a whole and/or one or more of the individual segment subsets. If the platform receives any lists of excluded contacts, regardless of the results of the AI-optimization model, those contacts will not be added to the target audience or segment as designated. This is particularly useful for users that are unable to determine how to modify or change their segments to achieve financial goals (e.g., more revenue) in a reliable and predictable manner.

In one embodiment, the platform is operable to receive an input of one or more financial metrics to optimize. For example, the platform is operable to receive a selection to maximize revenue or to optimize ROI, or provide a mixed strategy for the two and to operate the AI optimization using this information as a constraint.

The present invention is not, however, limited to only augmenting a particular input audience or segment. In one embodiment, the platform is operable to automatically identify segments of an audience input into the system. In one embodiment, these automatically identified segments are based on natural language processing of a description of a desired segment provided by at least one user device. In another embodiment, the segments are able to be automatically identified without any description or detail being provided regarding the segments.

In another embodiment, the platform is operable to automatically identify and generate a base audience for a particular marketing campaign. In one embodiment, the platform receives consumer spending data for a plurality of contacts from a user device associated with the marketing campaign via data input sources from one or more social media websites or other marketing firms, via received survey responses, and/or any other source of consumer purchase data. Thus, in one embodiment, the platform is operable to serve, at least in part, as a customer data platform (CDP), while, in another embodiment, the platform primarily receives data from third-party CDPs and from one or more user devices. In one embodiment, the platform then generates an audience for a particular campaign based on automatic text or image analysis of one or more materials associated with the marketing campaign, images of one or more products promoted by the marketing campaign, descriptions of the company running the campaign, previous audiences for previous marketing campaigns by the same company or similar companies, natural language processing of a description of the campaign provided by a user device, a preference for constraints to optimize (e.g., revenue, ROI, etc.), and/or other data.

In one embodiment, the platform is operable to integrate data from a customer success manager (CSM) or from a CSM platform and is operable to transmit information regarding the changes made by the AI-optimization model and a time at which such changes were made. The information is able to include a list of contacts removed or added as a result of the optimization model. This provides the CSM or CSM platform with the necessary information to assess the direct results of the AI-optimization performed by the platform, including the specific changes to costs and revenue attributed to the additional or removed contacts, allowing the user to view the practical effectiveness of the model on a specific campaign, or in general across multiple campaigns in aggregate.

In one embodiment, the platform is operable to display information regarding average performance of automated, AI-optimized audiences in the past, either for a particular campaign, for a particular company, or overall across the platform. In one embodiment, the platform is operable to display information comparing average performance of automated audiences to non-AI-optimized audiences for a particular campaign, for a particular company, or overall across the platform.

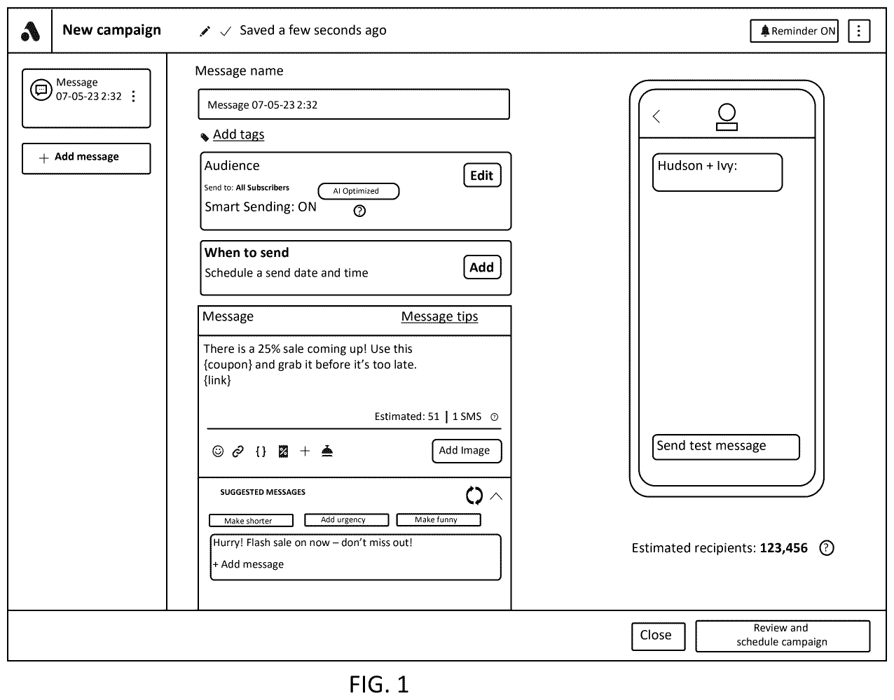

The present invention is able to include a user interface for users to personally customize their marketing campaign and to select both whether to use AI-based optimization of a target audience or audience segment and which AI-based optimization model to utilize. Segments are selected by the user device and represent contacts (or subscribers) that meet a heuristic condition (e.g., purchase in the last 30 days). Therefore, inclusions according to the present invention are expansions to the selected segments with additional high propensity contacts. Exclusions are removals of contacts from the selected segments, most preferably those contacts with low propensity or some other heuristic condition. In one embodiment, inclusions and exclusions are operable to be made by the artificial intelligence module of the present invention entirely or in part from inference of a proper audience based on the content of the message. One embodiment of the user interface is discussed below with reference to FIGS. 1-7.

FIG. 1 illustrates a graphical user interface for generating and modifying a targeted marketing campaign according to one embodiment of the present invention. The platform of the present invention includes a campaign creation tool and corresponding campaign creation interface configured to be displayed on a user device through a web-based page or mobile application. The campaign creation tool includes a bar showing existing messages in a particular campaign (shown on the left in FIG. 1) and including one or more buttons to add additional messages to the campaign, allowing the campaign to expand dynamically. If a selection of a particular message is received, the interface is configured to display details of the particular message, with an ability to edit those details before scheduling the campaign.

In one embodiment, details of the message include a message name, a schedule of when to send a particular message (e.g., a designation of one or more times, dates, or days of the week on which to send the message), content of the message (e.g., text, images, videos, hyperlinks, etc.), and/or an audience for the message (e.g., a list of contacts to which to send the message). In one embodiment, the audience is able to be wholly generated by an artificial intelligence tool of the present invention, manually entered into the interface, provided via an attached spreadsheet, and/or provided to the platform by other means. In one embodiment, the details include an image of a mobile device or other sample user device, showing how the message is likely to appear on the devices of contacts of the campaign. In one embodiment, the message details include an estimated number of recipients of the message in the campaign based on the selected audience.

The content of the message is able to be edited to change the text of the message, formatting of the text (e.g., bold, italicize, changing colors, font size, line spacing, etc.), to add or remove hyperlinks, to add or remove attached contents (e.g., an image), to add or remove emojis, to add or remove mathematical formulas or special characters, and/or other word processing tools. In one embodiment, the platform is operable to suggest message content, as discussed further below. In one embodiment, the tool displays a number of characters and/or words in the message. In one embodiment, one or more tags are able to be added to each message.

The modularity of the campaign design tool on the platform allows users to automatically change the audience of the campaign in real time, even after the campaign has largely been otherwise designed. This allows users to change their minds later to edit, remove, or add AI-optimization to their target audience.

In one embodiment, at least one AI-optimization model of the present invention is enabled by default in creating new campaigns via the platform of the present invention, or the platform is able to receive an input to enable the optimization models by default. In this embodiment, the AI-optimization tool begins optimizing the target audience for the campaign immediately when a new campaign window is loaded and a target audience is selected, rather than requiring an input from a user to begin the optimization process. In another embodiment, no AI-optimization model of the present invention is enabled by default, and instead must be enabled by a user device.

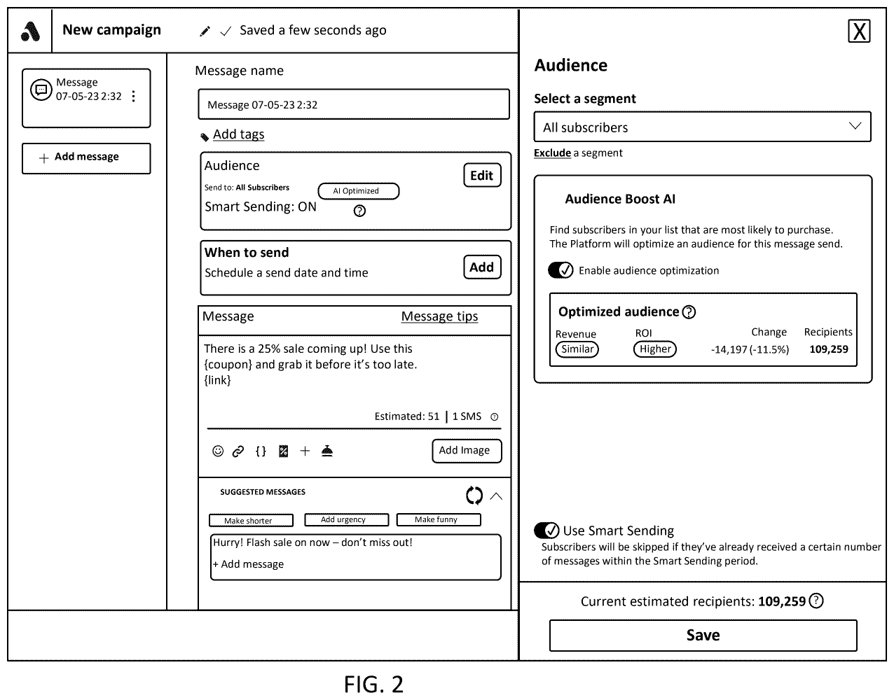

FIG. 2 illustrates a graphical user interface including a drawer for boosting an audience for a targeted marketing campaign according to one embodiment of the present invention. As shown in FIG. 2, the audience boost AI-optimization provides an indication of a total number of contacts eliminated from the previous audience or audience segment, a percentage change, and/or a total number of contacts included after the adjustment. In one embodiment, factors included to decide whether to include or exclude contacts using the audience boost AI-tool include time since last purchase, time since last click, time since joining a subscriber list, time since last view, time since last item added to a cart, views in the last 3 days, views in the last 10 days, views in the last 30 days, views in the last 60 days, views in the last 90 days, views in the last 180 days, views in the last 360 days, clicks in the last 3 days, clicks in the last 10 days, clicks in the last 30 days, clicks in the last 60 days, clicks in the last 90 days, clicks in the last 180 days, clicks in the last 360 days, cart additions in the last 3 days, cart additions in the last 10 days, cart additions in the last 30 days, cart additions in the last 60 days, cart additions in the last 90 days, cart additions in the last 180 days, cart additions in the last 360 days, purchases in the last 3 days, purchases in the last 10 days, purchases in the last 30 days, purchases in the last 60 days, purchases in the last 90 days, purchases in the last 180 days, purchases in the last 360 days, purchase total for the last 3 days, purchase total for the last 10 days, purchase total for the last 30 days, purchase total for the last 60 days, purchase total for the last 90 days, purchase total for the last 180 days, purchase total for the last 360 days, and/or additional variables. Additional factors include demographic information, brand information, analysis of the message content, and/or other behavior of the contacts. In one embodiment, the platform is operable to generate a spreadsheet and/or an additional webpage showing a list of contacts added or removed from the audience or segment via the AI-optimization tool. Being able to see the recommendations allows for transparency of the model and allows the user to assess if the modifications appear to meet the goals of the particular campaign or not. In one embodiment, the platform provides relevant information for each added or removed customer, such as number of conversions, average clickthrough rate, predicted future clickthrough rate, predicted likelihood of future conversions, and/or other information, allowing users to determine if they agree with the model's assessment to add or remove each contact. Predicted future clickthrough rate, predicted likelihood of future conversions, and/or other predicted quantities are based on historical click or purchase behavior of each contact and/or other attributes of each contact (e.g., demographic information, message contents, etc.).

In one embodiment, the platform further allows for individual contacts or segments of the audience to be added or removed after optimization, allowing for a high degree of customizability by the user. This is able to be done by click selection of individual contacts via a web interface, via uploading an amended version of a spreadsheet with the individual contacts readded or removed, or via other means. Alternatively, after displaying the suggested adjustments by the AI-optimization model, the platform is able to receive further inputs from the user device to adjust the constraints of the AI-optimization model or to further optimize based on additional or different factors. For example, in one embodiment, if a mixed ROI-revenue model is selected, the platform receives an additional request to increase revenue further, causing the platform to either switch to using a revenue maximizing model or tuning the mixed ROI-revenue model to more heavily weight increases in revenue. In another embodiment, after a model recommendation is generated, the platform receives a request to include at least a minimum number of contacts in the campaign and adjusts the model to meet this constraint.

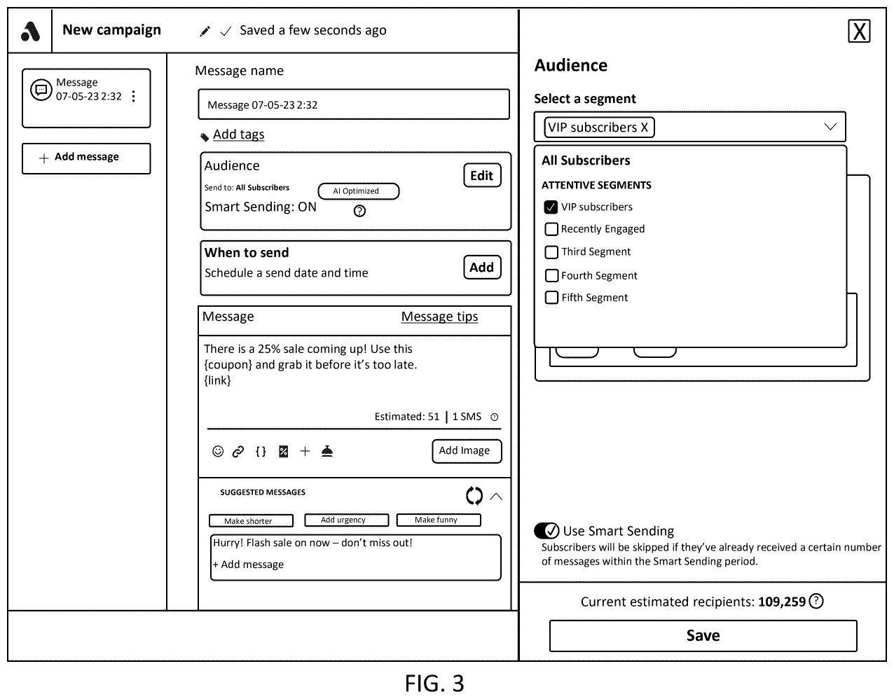

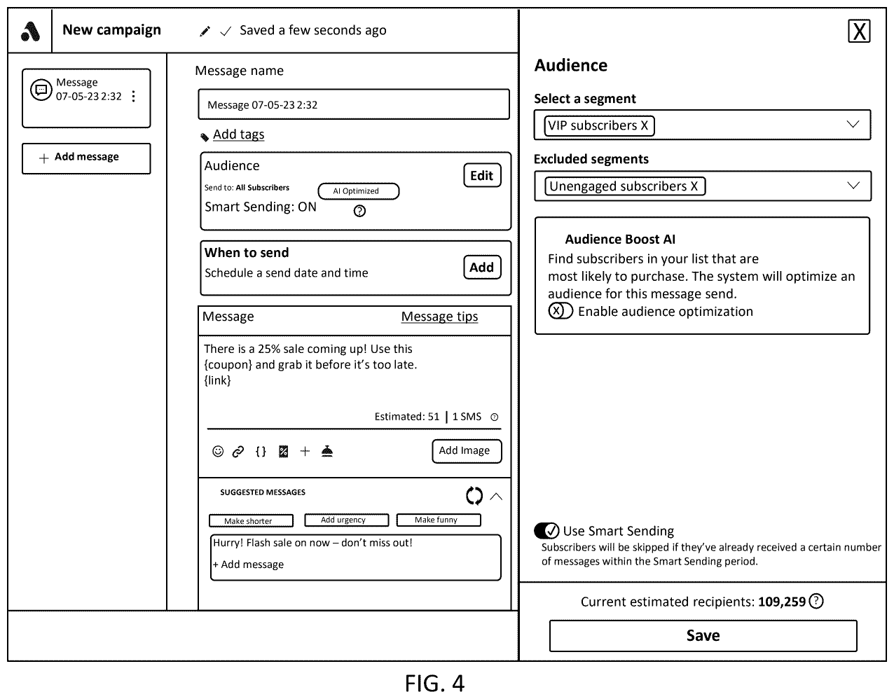

FIGS. 3 and 4 illustrate a graphical user interface including an audience boost function with an audience segment selection tool according to one embodiment of the present invention. The tool shown in FIGS. 3 and 4 allows for a specific segment (or an entire target audience) to be optimized by the AI-optimization tool. The platform receives a selection of one or more inclusion segments (or a selection of the entire target audience) from a user device and is optionally further able to receive a selection of one or more exclusion segments, designating those contacts that are not to be included in the suggested audience. In one embodiment, if an inclusion segment is selected, the AI-optimization tool is selected as “ON” by default and remains in the ON position if additional inclusion or exclusion segments are added. In one embodiment, if only an exclusion segment is selected, with no inclusion segments selected, then the AI-optimization tool is selected as “OFF,” and a toggle for switching between OFF and ON is disabled by default until an inclusion segment is added.

In one embodiment, once at least one inclusion segment has been selected, the AI-optimization tool immediately begins processing to determine an optimal change for the selected inclusion segment. In another embodiment, the platform only begins processing of the AI-optimization tool upon receiving a selection of at least one user. In one embodiment, selection of a new or additional inclusion or exclusion segment automatically halts any running AI-optimization processing. In one embodiment, the platform then automatically initiates new processing with the added inclusion or exclusion segments, while, in another embodiment, the platform does not immediately initiate new AI-optimization processing and instead waits for further user input. In another embodiment, selection of a new or additional inclusion or exclusion segment does not halt running AI-optimization processing, and instead, the processing proceeds with the previously designated segments. In one embodiment, opening the drop down menu shown in FIG. 3 with a list of segments does not halt any running AI-optimization processing.

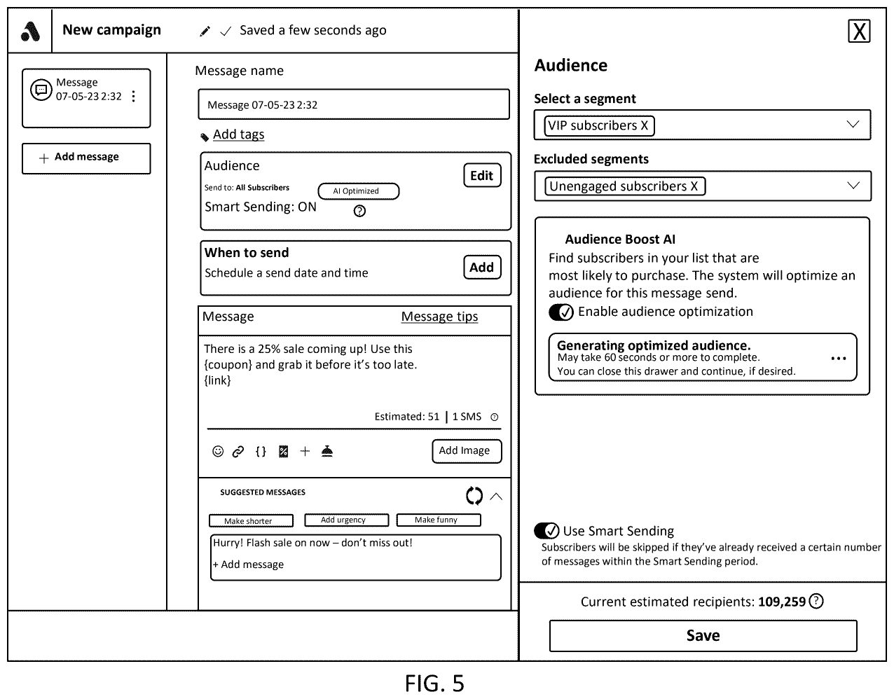

FIG. 5 illustrates a graphical user interface including an audience boost function with an audience segment selection and exclusion tool in the process of generating an optimized audience according to one embodiment of the present invention. In one embodiment, the AI-optimization tool is presented to the user in the form of a drawer or any other UI element. In one embodiment, if the drawer or other UI element is closed while the AI-optimization is in the process of generating an optimized audience, then the optimization process does not cease and continues generating the optimized audience. In one embodiment, the optimization process only continues after the drawer is closed if the platform has received a selection to “save” the process (e.g., via click selection). In one embodiment, if the platform receives a selection to send the campaign while the AI-optimization is still in the process of generating an optimized audience, then the campaign is sent out without the AI-optimization. In another embodiment, if the platform receives a selection to send the campaign while the AI-optimization is still in the process of generating an optimized audience, then a warning prompt is automatically generated and displayed on the user device. In one embodiment, if a campaign is sent out while the AI-optimization is in process, then a label is applied to the campaign in a campaign list or campaign description indicating that an AI-optimized audience was intended to be used but was interrupted before completion. In another embodiment, a notification is automatically transmitted to a user device indicating that an AI-optimized audience was not used if the AI-optimization process is interrupted by sending the campaign. In one embodiment, the platform automatically tracks how many campaigns have an AI-optimization process interrupted by sending the campaign.

In one embodiment, the AI-optimization is complete in approximately 75 seconds or less. In another embodiment, the AI-optimization is complete in approximately 30 seconds or less. In one embodiment, the interface is operable to display an amount of time remaining for an ongoing optimization.

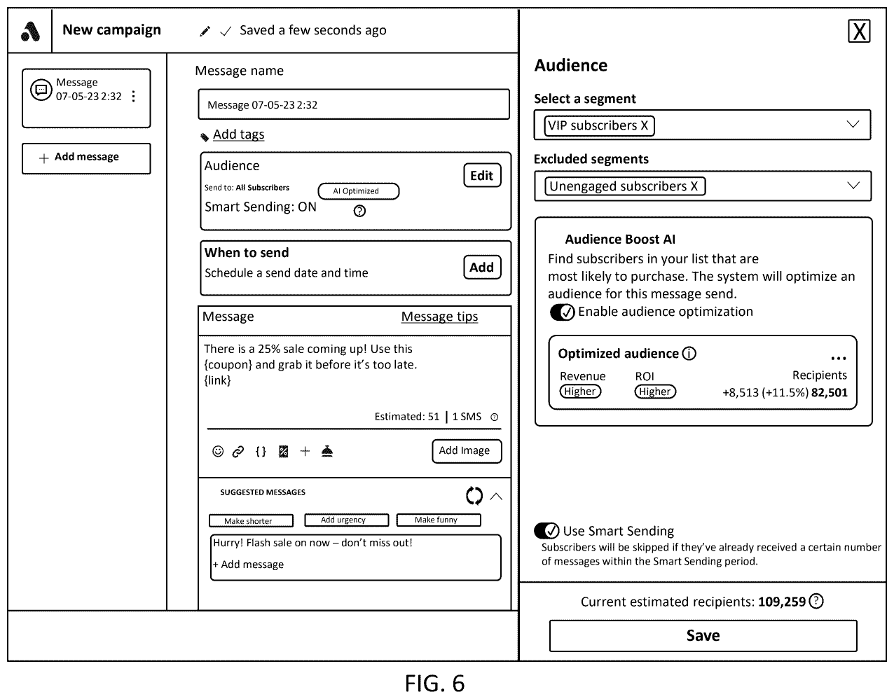

FIG. 6 illustrates a graphical user interface including an audience boost function with an audience segment selection and exclusion tool with a suggested optimized audience according to one embodiment of the present invention. As shown in FIG. 6, once the AI-optimization is complete, the user interface is configured to display details regarding the optimization, including, but not limited to, a new total estimated number of contacts for the campaign, a total change from the original audience or segment (e.g., +/−number of contacts, % change, etc.), and/or financial directional statistics (e.g., Higher, Lower, or Similar Revenue, Higher, Lower, or Similar ROI, etc.).

In one embodiment, if the AI-optimization tool does not generate any changes relative to the original target audience, then the system will display that no AI-optimized results were found, and the campaign is not labeled as being AI-optimized.

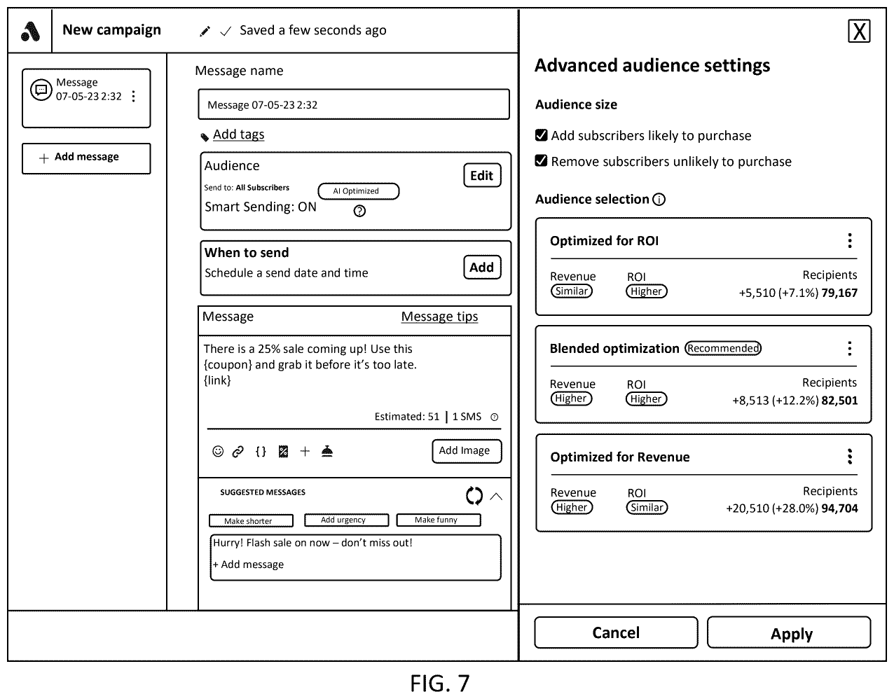

FIG. 7 illustrates a graphical user interface including an audience boost function with an audience segment selection and exclusion tool with a plurality of options for optimizing an audience according to one embodiment of the present invention. In one embodiment, the platform is operable to display a plurality of different optimization schemes based on optimizing for different quantities. Examples of optimization types include, but are not limited to, ROI maximizing, ROI boosting, neutral ROI, revenue boosting, and revenue maximizing. Breakpoint of contact propensity is determined via curve fitting probability to conversion and revenue. Therefore, the breakpoint's correspondence with revenue or ROI is able to be determined. The specific optimization type used is selected by a user device through a user interface. In one embodiment, as shown in FIG. 7, the platform only includes a limited number of all optimization types (e.g., displays 3 out of 5). Each optimization scheme displays a new total estimated number of contacts for the campaign, a total change from the original audience or segment (e.g., +/−number of contacts, % change, etc.), and/or financial directional statistics (e.g., Higher, Lower, or Similar Revenue, Higher, Lower, or Similar ROI, etc.). In one embodiment, if the platform only displays a limited number of optimization types, it preferentially displays the three highest revenue options, but one of ordinary skill in the art will understand that other embodiments are also contemplated herein. Furthermore, in one embodiment, the platform displays a “recommended”label on at least one of the displayed optimization schemes.

In one embodiment, the “recommended” label is applied to either a revenue boosting or neutral ROI scheme, if available, with the revenue boosting scheme preferred over the neutral ROI scheme. In an embodiment, if the only schemes able to be generated by the AI-optimization tool are ROI maximizing and ROI boosting, then the ROI boosting scheme is labeled as recommended. In an embodiment where only a single scheme is able to be produced, then that scheme is automatically labeled as “recommended.”

In one embodiment, for the ROI maximizing scheme, the financial directional tags displayed are “Revenue Similar” and “ROI Maximized.” In one embodiment, for the ROI boosting scheme, the financial directional tags displayed are “Revenue Boosted” and “ROI Boosted.” In one embodiment, for the neutral ROI scheme, the financial directional tags displayed are “Revenue Boosted” and “ROI Similar.” In one embodiment, for the revenue boosting scheme, the financial directional tags displayed are “Revenue Boosted” and “ROI Lower.” In one embodiment, for the revenue maximizing scheme, the financial directional tags displayed are “Revenue Maximized” and “ROI Lower.”

Preferably, each of the AI-optimization schemes is processed and generated in parallel, rather than sequentially, such that the schemes are able to be displayed on the user device at the same time and such that the optimization tool does not take up three times the amount of time.

In one embodiment, if the platform receives a click selection (or another means of selection) of an AI-optimization scheme from a user device and, optionally, receives a selection to save, then the selected AI-optimization scheme is applied to the campaign. In one embodiment, once an AI-optimization scheme is applied to one campaign, that scheme is automatically enabled or recommended for future campaigns by the same company or client of a marketing firm. In another embodiment, the platform automatically generates a prompt with an opt-in selection for making the AI-optimization scheme a default or not for future campaigns by the same company or client.

In an embodiment in which segments of a target audience are generated without an initial basis segment by the platform, the platform first receives input of an AI-optimization scheme (e.g., revenue boosting, etc.) from a selected list. In one embodiment, the selected list includes basic information regarding how large the selection of contacts is, relatively speaking, for the AI-optimization scheme, what the scheme is seeking to optimize, and/or other information. After receiving this selection, the platform is operable to either automatically begin generating one or more recommended segments according to the selected scheme or prompt for additional input information (e.g., desired segment size) before beginning generation.

Recommended segments do not need to be used in isolation but are able to be used in combination with another segment, such as an existing “engaged” segment, to ensure users in the engaged segment are also reached. In one embodiment, the platform automatically cross-correlates between contacts in multiple different selected segments and removes duplicate contacts, such that contacts in each segment are not double contacted for the campaign.

In one embodiment, the application or web-based interface of the platform includes a page having a list of campaigns created through the platform by a particular user profile or user device. The list of campaigns preferably includes icons designating whether the campaigns utilized an AI-optimized target audience for easy identification of where the tool has been used and therefore easier assessment of the impact of such a tool. In one embodiment, for marketing firms, the list of campaigns is able to be sorted or divided by client of the marketing firm via receiving data from a CSM or other individual, or integration via an API with a CSM platform or other platform, the performance of these campaigns and the impact of the AI-optimization of these campaigns is then able to be viewed and assessed. In one embodiment, any party is operable to view a performance of a campaign and an impact of a campaign.

In one embodiment, the platform is operable to automatically receive, via an API with a CSM platform or other third-party source, 0 day click revenue information regarding a campaign's revenue from the AI-optimized audience as opposed to the rest of the audience of the campaign. This is able to be displayed to a user on the web-based interface or application of the platform of the present invention. For example, the platform is able to note that the original audience included 100 contacts, 40 were excluded by the AI-optimization, and 20 were added by the AI-optimization, for a total of 80 contacts. While the entire campaign makes $100, $40 of that comes from the 20 added by the AI-optimization. Thus, the revenue per send of the original campaign is $0.60 ($60/100), and the revenue per send of the AI-optimized audience is $2.00 ($40/20), marking an increase of 233% compared to the original campaign. However, the statistics able to be obtained include not only revenue per send but also additional performance metrics such as conversion metrics, clickthrough rate metrics, opt-out rate metrics, ROI, and/or combinations of one or more metrics for a company or marketing firm client over a time period for one or more campaigns.

### Send Time Optimization

After an e-commerce boom during the COVID-19 pandemic of 2020-2021, many merchants have struggled to maintain their online sales and user retention. One issue is ensuring that marketing messages are sent at a relevant time likely to elicit clickthrough and ultimately purchase by contacts and a reduction in opt-out rate. Even a boost of 3-5% in clickthrough rate provides a potentially enormous benefit to companies'utilization of marketing campaigns. The present invention utilizes artificial intelligence-boosted send time optimization systems to more efficiently target potential consumers at a time likely to lead to conversion. Advantageously, send-time is operable to be optimized based on day, time of day, hour, and even down to a minute or range of minutes, providing for a system that provides a higher effectiveness of consumer conversions than the prior art.

In one embodiment, the platform provides a heuristic-based, contact-level send time recommendation based on each contact's most common page viewing time (such as a viewing hour). In one embodiment, the heuristic is based on an hour determined to be optimal for total clicks. In this embodiment, the platform is configured to receive information corresponding to identities of devices accessing a page of a website or application for a particular company, including timestamp information, and to correlate those identities with individual contacts to determine when contacts most frequently access the website or application and/or most frequently access particular pages of the website or application. Send time recommendations are operable to be based on various other factors alone or in combination, including but not limited to environmental data for groups of users, such as weather data (e.g., sunny weather, hot weather, snow, rain, thunderstorms, etc.), events near groups of users, such as music festivals and sporting events; and holidays, such as Independence Day, Thanksgiving, and Christmas.

In one embodiment, the send-time recommendation is generated by the artificial intelligence module of the platform, which is operable to be trained through a plurality of exploratory sends and/or historical data. The exploratory sends include sending marketing messages at times relative to a contact's common viewing times (such as a common viewing hour) and validating clickthroughs and purchases (i.e., conversions) of contacts for each timing, thereby helping to determine optimal send times relative to page view data for contacts with different characteristics (e.g., different for users acting from different device types, different for users from different countries, etc.). Furthermore, the exploratory sends provide an indication of the amount of improvement in revenue and clickthrough able to be provided through the optimization, such that a predicted amount of improvement in these quantities, or other measures, are able to be generated and displayed on a user device.

The historical data includes prior marketing campaign data, competitor marketing campaign data, historical product pricing data, total number of products purchased, past purchaser location, number of product views, products added to an online shopping cart, past purchaser demographics, number of advertisements for a product, market trends, and/or any other relevant historical data for the artificial intelligence engine to optimize a marketing campaign.

In one embodiment, exploratory sends and/or historical data are used to train the artificial intelligence-based send-time optimization model on a company or client level. In this embodiment, if send-time optimization is enabled, some percentage of the contacts in the audience for the campaign are designated as exploratory, with these contacts preferably being selected randomly or being the first contacts for which relevant trigger events occur, with the system training the model based on optimal results retrieved based on the send time for the exploratory group, wherein the updated model is used for the remaining contacts.

In one embodiment, the platform prevents send time optimized messages from being transmitted during “quiet hours” (e.g., normal sleeping hours) to prevent consumer frustration, legal issues, or annoyance. In one embodiment, quiet hours are set for each particular time zone and are defined on a time zone level. In another embodiment, quiet hours are custom provided as part of the campaign (e.g., the platform receives a selection to designate quiet hours as only being between 1 AM and 5 AM in local time).

In one embodiment, the send time optimization tool is operable to be activated or deactivated via selection (e.g., click selection, etc.) from a user device via a campaign creation or editing interface. In one embodiment, send time optimization is automatically disabled for messages to be sent out the same day (or within a predetermined time range) that the campaign is launched. In one embodiment, if a send date is chosen and send time optimization is selected for a first message, and the platform receives a selection to send an additional message on the same date, the platform automatically sends a warning notification to the user device, indicating that such an indication will possibly cause the messages to be sent out of order. In one embodiment, the platform then sends a prompt to confirm the addition of the second message. In one embodiment, the platform prevents the additional second message on the same date as a previously scheduled send time optimized message or automatically deselects send time optimization for the previous message.

In one embodiment, the platform is operable to receive an input to designate a particular message as participating in an A/B, or bucket, test with regard to send time optimization. In this embodiment, the platform is operable to receive a selection of a “normal” or “default” send time and send some messages to the audience at the normal or default time, while sending other messages at the time selected via send time optimization. The platform is operable to track which contacts were in which group and what time messages to each contact were sent, such that changes to revenue, clickthrough rate, opt-out rate, ROI, or other metrics as a result of the send time optimization are able to be tracked.

### Brand Voice & Vision Matching

Another issue for brands in a marketing campaign is the content of the messages sent during the campaign. While AI and ML, including large language models (LLMs), have the potential to increase the efficiency of creating messages for these campaigns, results of attempts at such AI-enhancement have been unpredictable and unstable in the past, as tendencies of LLMs to hallucinate words, to create messages that are directly harmful to a brand (e.g., using profane language, using unprofessionally bad grammar or spelling, etc.), or at least don't align with a brand voice have led to hesitancy to use such tools extensively in designing a marketing campaign. However, the present invention addresses such inconsistencies of past LLM-systems for providing for efficient campaign design matching the voice of a brand.

Brand voice, according to the present invention, includes several different qualities that affect how messages by the brand “sound.” One quality of brand voice is the tone, which includes the formality of greetings commonly used, qualitative adjectives of the messages (e.g., sarcastic, informative, etc.), and/or other aspects of the brand voice. Another quality of brand voice is the actual content, such as whether the brand commonly uses puns or uses particularized greetings (e.g., “hey people!”) or other details about the actual text of messages. Another quality of brand voice includes general message settings, such as length of messages, use or non-use of emojis, punctuation themes (e.g., using “>” vs. “:”, never using exclamation points, etc.).

In one embodiment, the platform is operable to receive one or more messages from a user device with a freeform text description of a brand voice from a user device, such as a marketing firm providing brand voice descriptions of each individual client or a company providing a brand voice description of itself to the platform. In one embodiment, the platform is operable to utilize natural language processing (NLP) to interpret and analyze the content of the description and determine one or more categories into which the description falls (e.g., fun, professional, etc.) or one or more qualities of the description (e.g., child-directed, colorful, bright, etc.) in order to provide context for the artificial intelligence module of the platform to develop messages for a campaign. However, in another embodiment, the platform does not receive freeform text descriptions in generating the brand voice description. In another embodiment, the platform is operable to receive selection of one or more preestablished categories from at least one user device to provide a description of the brand voice. For example, in one embodiment, the interface for the platform includes a plurality of tag buttons designating known qualities (e.g., fun, professional, joking, etc.) that are able to be selected to provide context for the artificial intelligence module of the platform to develop messages for a campaign. In another embodiment, the platform generates and displays a plurality of questions regarding brand voice and receives responses (e.g., multiple choice selection) to each of the questions to provide context for the artificial intelligence module of the platform to develop messages for a campaign.

In another embodiment, the platform determines a brand voice for a particular client or company by receiving a plurality of messages representing previous materials used in prior campaigns or sample messages to be used for future campaigns. In one embodiment, the platform is operable to utilize natural language processing (NLP) to interpret and analyze the content of the previous or proposed materials and determine one or more categories into which the brand voice falls (e.g., fun, professional, etc.) or one or more qualities of the brand voice (e.g., child-directed, colorful, bright, etc.) in order to provide context for the artificial intelligence module of the platform to develop messages for a campaign. Specifically, previous materials are useful in ensuring that the platform is able to generate content that is consistent in terms of tone, punctuation, and writing style with the previous materials. In one embodiment, the platform receives one or more designated restricted words, emojis, or phrases (e.g., off brand terms or phrases, profanity, etc.) or negative examples illustrating samples of materials that represent what the client or company does not want to include. In one embodiment, the platform automatically restricts inclusion of any restricted words, emojis, or phrases and optionally restricts inclusion of any word forms or simple variations of restricted words, emojis, or phrases from any content generated by the artificial intelligence module for the brand. Negative examples are further able to provide context to prevent the artificial intelligence module from generating content similar to the negative examples.

Using either freeform input and/or selection of predefined inputs, the platform is operable to provide controls and guardrails allowing user devices to customize and tune a brand voice in a consistent and predictable manner. Using these abstractions, the platform populates a series of values (e.g., tone-witty, sarcastic, use CAPS sparingly, etc.) in a front-end user interface to describe a brand's messaging characteristics. In one embodiment, these values are able to be edited, and the edits make changes to the generated prompts that populate a front-end preview tool (e.g., to preview generated messages) in the user interface, such as the display shown on the right side of FIG. 1. The values are able to be filtered for word choice and length to reduce the risk of the artificial intelligence module generating offensive or hallucinated messages.

In one embodiment, the platform is operable to present a summary of the brand voice qualities determined by the artificial intelligence module for review by a user. The platform is operable to receive inputs to edit the brand voice summary to further refine the description for increased accuracy.

Once the brand voice is established, in one embodiment, the platform utilizes a quality-checking LLM for any content generated by the artificial intelligence module. The quality-checking LLM is operable to analyze the content generated by the artificial intelligence module to ensure compliance and accuracy of the content with brand voice qualities. Using NLP, the quality-checking LLM verifies that the content generated by the artificial intelligence module properly fits into categories into which the brand voice falls (e.g., fun, professional, etc.) or one or more qualities of the brand voice (e.g., child-directed, colorful, bright, etc.) in order to ensure the artificial intelligence module of the platform develops quality messages for the campaign. In doing so, the quality-checking LLM determines if the content generated by the artificial intelligence module is consistent in terms of tone, punctuation, and writing style with the brand voice. The quality-checking LLM reviews the content for restrictive words, emojis, and/or phrases, and variations thereof, to ensure restrictive words, emojis, and/or phrases are not included in the content. Further, the quality-checking LLM is operable to prevent hallucinations by the artificial intelligence module by verifying the sources from which the content was generated by the artificial intelligence module.

After the quality-checking LLM reviews the content generated by the artificial intelligence module, the quality-checking LLM is operable to suggest revisions to the content, automatically modify the content, and/or generate a quality score. In one embodiment, the quality-checking LLM modifying the content includes modifying objectively verifiable data such as offers, names, and/or anything else coded into the content. In one embodiment, the quality-checking LLM modifying the content includes flagging subjective data such as spelling, grammar, sentence structure, etc. In another embodiment, the quality-checking LLM is operable to modify objective and subject data of the content. In one embodiment, the artificial intelligence module is operable to update the content based on the quality-checking LLM review, wherein the quality-checking LLM is operable to iteratively review the content until the quality-checking LLM determines the content exceeds a quality score threshold and/or the quality-checking LLM does not change and/or suggest changes to the content. In one embodiment, the quality score threshold is dynamically adjustable for a particular marketing campaign and/or user tolerance. In another embodiment, the platform presets the quality score.

The platform is further able to prevent the artificial intelligence module from producing content that is non-compliant with one or more legal restrictions. In one embodiment, for clients or companies involved in industries with tight restrictions on marketing (e.g., health, wellness, legal services, etc.), the platform is operable to receive a document including legal regulations regarding advertising from a user device or via automatic retrieval from one or more government websites. The platform is operable to utilize NLP to analyze the contents of the legal regulations, and the artificial intelligence module is operable to determine restrictions for constructing a particular campaign based on the legal regulations. In one embodiment, the platform further receives a freeform text description of how the advertising products or services for a marketing campaign interact with applicable legal restrictions (optionally including information identifying the legal restrictions such that they are able to be retrieved with a web crawler) from a user device. The platform is operable to use NLP to analyze the content of this description to determine restrictions for constructing a particular campaign based on the legal regulations. In one embodiment, the platform is operable to use the quality-checking LLM to ensure compliance with the one or more legal restrictions. The quality-checking LLM is operable to use NLP to analyze the content and cross-reference the content against knowledge of legal information (e.g., laws, regulations, codes, ordinances, etc.) to ensure the content is legally compliant. The quality-checking LLM is operable to be fine-tuned for particular legal and/or geographic jurisdictions.

The platform is configured such that the artificial intelligence platform is operable to generate 0% egregious content (e.g., content that is profane, against compliance, obscene, etc.). However, one of ordinary skill in the art will understand that egregious content is not limited to only profane or obscene content but also includes content that is far off from brand guidelines (explicit or implicit), content that is improper for specific circumstances, content that has unintelligible language, and/or other factors.

Based on the determined brand voice, the artificial intelligence module of the platform is operable to generate text, associated images, hyperlinks, and/or other content in messages for a marketing campaign. In one embodiment, the platform is operable to use the quality-checking LLM to verify the generated text, associated images, hyperlinks, and/or other content in messages for the marketing campaign are consistent with the brand voice and legally compliant before finalizing the content. In one embodiment, after the quality-checking LLM finalizes the content, the content generated by the artificial intelligence module is previewed and displayed on the interface, and the platform is able to receive inputs to edit these messages to allow further customization and refinement of the messages by the user. Types of messages able to be generated for a campaign or otherwise include blast messages delivered to a set of contacts at a specific time as part of a campaign or trigger-based messages delivered upon a specific type of event (e.g., onboarding or offboarding of a subscriber).

In one embodiment, the generated messages include trigger-based messages based on a template. Examples of trigger-based template messages include, but are not limited to, welcome messages, browse abandonment messages, session abandonment messages, and/or other messages. In one embodiment, the platform receives text input from a user device to generate the message templates, while, in another embodiment, the artificial intelligence module of the platform automatically generates the message templates. In one embodiment, the message template includes one or more dynamic fields that are operable to be automatically filled when a message is sent based on factors including, but not limited to, a time, a date, a name of the recipient, and/or other contextual factors. For example, a welcome message is able to include a field for the recipient's name and/or a field for a time of onboarding of the contact, and the platform is able to automatically fill these fields based on information received by the platform for the particular contact. In the event that necessary information is not received (e.g., a name for the contact is not properly entered), in one embodiment, the platform is operable to automatically reformat the template message to convey the same message without the need for the name, thereby preventing a situation where either the lack of information prevents the message from sending or the message sends with an awkward placeholder for the name of the contact.

In one embodiment, the messages generated by the artificial intelligence module are operable to be customized to each different contacts'specific situation. For example, in one embodiment, the messages are able to have any currency quantities automatically converted to a local currency specific to the contact. In one embodiment, the local currency for a particular contact is able to be determined based on the phone number (e.g., country code) or email (e.g., URL code) of the contact, based on geolocation data of the user device to which the messages are sent, and/or based on past history of interactions with the user device (e.g., previously purchased a product with a particular currency). In one embodiment, conversion is based on automatic retrieval of a conversion rate for a particular currency from one or more online financial sources and/or based on existing listing prices by the company for the same good in the particular currency.

In another example, messages are able to convert to a local language specific to the contact. In one embodiment, the local language is determined based on the phone number (e.g., country code) or email (e.g., URL code) of the contact, based on geolocation data of the user device to which the messages are sent, device settings for the at least one contact, and/or based on past history of interactions with the user device (e.g., previously responded in a particular language). The artificial intelligence module is operable to use natural language processing to automatically translate the message to the designated local language. In one embodiment, the quality-checking LLM is operable to re-analyze translated messages to ensure the translated message remains compliant with brand voice and legal regulations. However, in other embodiments, the messages are not translated and are transmitted in the original language in which the messages were written for all recipients.

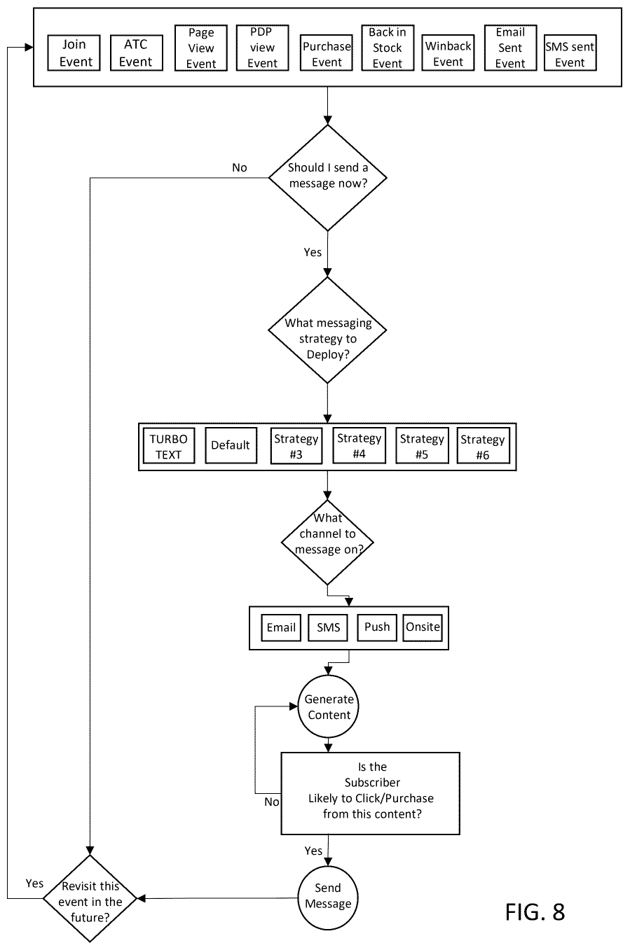

FIG. 8 illustrates a schematic diagram for determining how to execute a marketing strategy according to one embodiment of the present invention. FIG. 8 provides one example of a decision tree for determining whether and how to send a marketing message according to one embodiment of the present invention. In one embodiment, the platform receives notice that a trigger event has occurred, including, but not limited to, a join event (e.g., a new contact subscribes to a company), an add to cart (ATC) event (e.g., the platform detects that an online shopper has added an item to a virtual cart of the company), a page view event (e.g., a user device has visited a site or a particular page of a company), a product details page (PDP) view event (e.g., a user device has specifically visited a page including product details), a purchase event (e.g., a user device has provided inputs to purchase a particular product), a back in stock event (e.g., a particular product is back in stock), a winback event (e.g., a particular contact has not engaged with the company, its site, and/or its app for more than a threshold period of time), an email sent event, and/or a text sent event. Each of these trigger events, as well as other trigger events, is able to be configured to have its own workflows with unique messages, message channels, and/or other tools to cater to each situation. Different marketing campaigns are able to either have a message sent upon a trigger event occurring, have a message sent if additional conditions are met (e.g., another message has not been sent to the same contact within a day), and/or not send any messages as is needed in each particular case.

Based on the workflows established for a particular campaign or general company marketing scheme, after a trigger event, the platform first determines if a message should be sent. If the workflow does not include information about the event, or one or more additional conditions for the trigger event have not been met (e.g., the contact was already sent a message on the same day), then a message is not sent, and the platform is able to check upon future instances of the trigger event if a message should be sent, when perhaps additional conditions have been met or if a new workflow is established for the particular trigger event in the future. Further, the platform evaluates the likelihood that sending the message would cause an opt-out and/or cause conversion (i.e., sending the message would result in a purchase). As such, the platform is operable to determine that the message should not be sent if the message is likely to cause an opt-out and/or fail to cause conversion, despite the one or more additional conditions being met.

If the system determines that a message should be sent, the system determines what messaging strategy should be used, based on stored criteria designating particular messaging strategies for different trigger events. For example, the system determines what messaging strategy should be used based in part on user preference. To illustrate further, the system is operable to predict a variant of a messaging strategy that is most likely to cause conversion. In this embodiment, the system utilizes behavioral and demographic data to determine which variant of the messaging strategy is most aligned with the preference of the user. In one embodiment, if a messaging strategy is not selected for a particular trigger event, a default messaging strategy is used. In one embodiment, the system also determines through what channel (e.g., email message, push notification, text message, on-site message, etc.) to send the message based on preestablished workflow specifications for the particular trigger event.

In one embodiment, after determining how to send the message, the message is generated and sent to a user device (e.g., a smartphone, smart watch, tablet, computer, etc.) associated with the contact. In one embodiment, the artificial intelligence module generates the content of the message in real time in a manner that aligns with the brand voice of the company, while, in another embodiment, the content of the message is already previously generated or received from an input user device, and the system simply sends the message to the contact user device.

### AI Concierge

In one embodiment, for text-based messaging transmitted by the platform, the platform is operable to provide an AI-based concierge configured to receive responses from the user device to which the text-based messages were sent and automatically generate a response to the user device in return. For example, the AI-based concierge is configured to automatically respond to complaints regarding delivery or purchase, questions regarding a specific product, general inquiries regarding available products for a company, or other questions as necessary.

The AI concierge is configured to both provide consumers with a more personalized and helpful experience, as well as drive revenue for the companies for which it is responding. As such, providing product links and focusing on responses that are helpful for driving conversion are key focuses of the AI concierge.

In one embodiment, the AI concierge is configured to receive information regarding a brand voice, including by NLP analysis of text-based descriptions, previous and proposed future brand messages, and/or one or more selected qualities or values of the brand. The AI concierge is configured to generate responses consistent with the brand voice in terms of values, tone, general length of response, and/or other qualities to maintain brand integrity and prevent harmful, offensive, or generally off-brand responses from being generated. In one embodiment, if the AI concierge receives a response requesting a human agent or states something beyond the parameters of allowed conversation (e.g., the conversation becomes overly confrontational), the AI concierge is configured to automatically put the customer in contact with a human agent, provide contact information for one or more human agents, and/or provide a hyperlink helpful for resolving the particular issue at hand.

In one embodiment, the AI concierge further utilizes user-specific data to provide context for the conversation, including but not limited to demographic info for the contact (e.g., household income, gender, age, location, etc.), behavioral information for the contact (e.g., unused offers, propensity to buy, PDP pages visited, current purchases, past purchases across one or more brands, previous opt-outs and opt-out triggers, etc.), and/or conversational information (e.g., stated interests in terms of products or needs, priorities such as cost, etc.).

Generally, the tone of the AI-concierge generated messages is configured to maximize the likelihood that a consumer makes a purchase. For example, in one embodiment, the AI-concierge is operable to determine that the consumer has a fear of missing out on a product if the consumer fails to buy the product. In this embodiment, the tone of the AI-concierge is urgent such that the consumer feels like they want to buy the product immediately. In one embodiment, the tone of the AI-concierge is reassuring about purchases such that the AI-concierge provides assurances that particular products fit the consumer's needs and are things that other individuals are generally excited about and interested in.

In one embodiment, the platform is operable to use natural language processing to assess milestones for concierge engagement with each user. In one embodiment, an exemplary milestone includes indications of gratitude by a consumer, which indicates a successful interaction, resolved support issues, product inquiries, customer conversion through concierge-provided links, and/or other metrics. These metrics are able to be viewed by an organizer of the campaign to demonstrate the net effect of the use of the concierge on overall revenue and user satisfaction.

In one embodiment, the AI-based concierge is operable to transmit follow-up messages at a predefined or learned cadence. In one embodiment, after a conversation mentions a product or after an initial message, if no response or conversion has been achieved in 24 hours, then the AI-based concierge will automatically transmit a follow-up confirming interest in the product. If no communication is received for a second day, then the AI concierge will send a message including recommendations of similar products. In another example, if no response is received after 24 hours regarding an unused offer, the AI concierge will transmit a message clarifying if help is needed for finding the right product for the offer. If a further 24 hours pass without use of the offer, then the AI concierge is able to transmit one or more suggested items for use of the offer. One of ordinary skill in the art will understand that the cadence mentioned for the above examples is illustrative only, and the present invention is not limited to only gaps of 24 hours but is able to pace the cadence at any suitable level (e.g., 20 minutes, 1 week, etc.). In one embodiment, this cadence is only triggered where an artificial intelligence module determines that an “intent” of the conversation matches sales potential (e.g., product inquiry, discount codes, etc.). In one embodiment, the AI concierge includes a capped maximum number of follow-ups without receiving a response (e.g., 1 follow-up, 4 follow-ups, etc.).

In one embodiment, a user is operable to interact with the AI-based concierge. In one embodiment, the AI-based concierge is operable to be activated through the new campaign creation or campaign editing tool. The platform receives a selection to enable or disable the AI concierge (e.g., via click selection) in response to a particular message or as part of a campaign more broadly.

In one embodiment, during the time in which the AI concierge is generating a response, a bubble appears in the text interface, stating that the concierge is generating a response.

In one embodiment, the artificial intelligence module used on the platform is a native AI specific to the platform. In another embodiment, the platform includes an application programming interface (API) plug-in with at least one external artificial intelligence system (e.g., GPT 4, GPT 3.5, etc.).

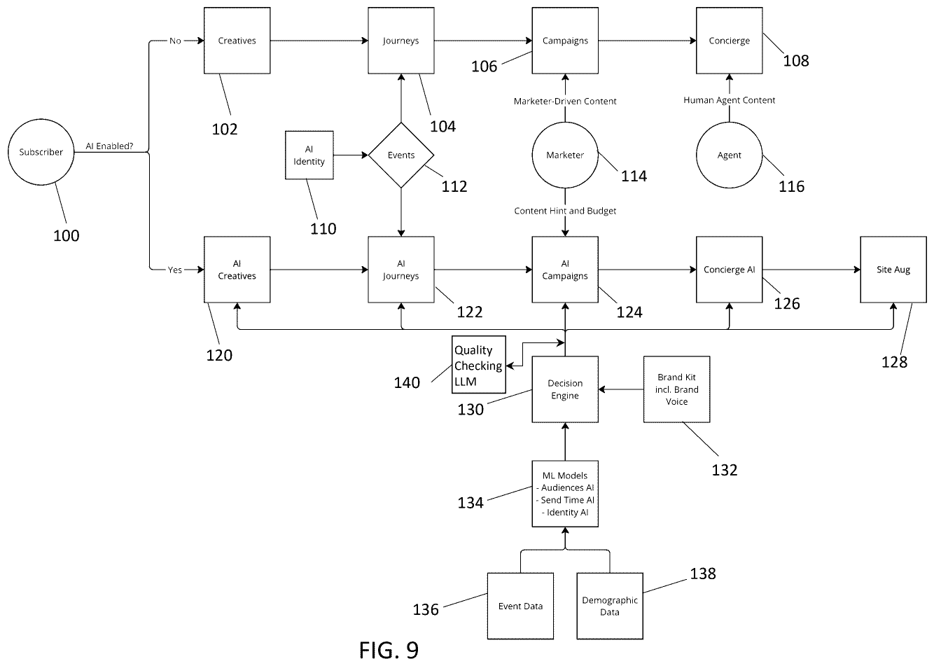

FIG. 9 is a schematic diagram of a marketing campaign enhancement system according to one, non-limiting, embodiment of the present invention. In one embodiment, the platform receives a request to initiate a process by a subscriber user device 100 (or company user device). The platform is operable to proceed via AI-enabled and/or non-AI-enabled paths (e.g., heuristic-based paths) for performing various processes. These creatives are operable to be used as displayed ads on a webpage or as part of messages to be sent to contacts as part of a marketing campaign.

In the non-AI-enabled path, the platform is operable to receive input from a user device to generate creatives 102, defined as ads served to users on a webpage or application, to drive opt-in to a marketing campaign. These creatives are operable to receive click selection or text entry for information such as phone number, email, or other contact information operable to be used to increase the number of contacts for a particular marketing campaign. The creatives are operable to include user inputted images, videos, audio, and/or other content. The platform is also operable to provide for design of customer journeys 104 based on user input. The user input is operable to include designation of specific types of events 112 (e.g., purchases, time passed after purchase, other activity, etc.) upon which messages are transmitted to a user device associated with each customer. Each part of this process, including the timing of the messages, content of the messages, types of events, etc. are operable to be input by a user device of the company designing the journey, generated automatically based on heuristic criteria, and/or based on AI models. Even for embodiments where the journeys are by and large not AI-based, the platform is operable to utilize AI-based identities 110 of contacts to inform steps of the journey, such as the events 112 triggering steps of the journeys 104.

The system also provides for non-AI-based creation of marketing campaigns 106. The platform is operable to receive direct content for the campaign 106 (e.g., content of messages, images, emojis, etc.) from a marketer user device 114 as well as other parameters for the campaign 106, such as the timing of messages, intended audience, and/or other qualities. Once messages are sent as part of a campaign or customer journey, the platform is operable to facilitate a chat connection (e.g., concierge 108 functionality) between the recipient user device and a user device 116 of a representative of the company, allowing for direct, human response to any questions, concerns, or comments by the recipient user device, allowing for more user engagement.

Alternatively, the platform is operable to facilitate AI-based marketing design and enhancement. For example, the platform is operable to receive prompts from a user device to design AI-based creatives 120 for the platform, including text information, images, video, audio, and/or other aspects that are operable to be displayed on a website or app of the company, sent via a marketing campaign or customer journey, or otherwise utilized. In one embodiment, the AI-based creatives 120 select a page on a website in which a signup unit is displayed based on any number or combination of signals, such as source of a session, page view number, time on page, buttons clicked on the page, scroll depth of the page, the way the page is being browsed, and/or other signals. Thus, the signup unit is able to be generated on a second page or a third page, or any other page, based on a set of reasons for a particular user, but potentially displayed on a different page for another user for a different set of reasons, as opposed to hardcoding rules for exactly where the signup page appears for all subscribers.

These creatives help to drive opt-in to a particular marketing campaign such that the base of the campaign is operable to be expanded. The platform is also operable to automatically design customer journeys 122 for particular events 112 or for multiple types of events 112. Furthermore, the platform is operable to determine which events 112 trigger a journey 122. This design is operable to be based on AI-interpretation of user prompts for the goals of customer journeys, historical data for previous customer journeys by the company or similar companies, and/or other information. The AI-based journeys 122 are operable to leverage the same or similar machine learning models 134 for optimizing audience, send time, message contents, or other parameters for the messages sent. In one embodiment, the AI-based journeys 122 are operable to determine optimal days (e.g., holidays) on which to send marketing campaign messages and determine ideal contents of the message (e.g., information regarding a holiday sale). In one embodiment, the AI-based journeys 122 provide for unique messages per subscriber to be sent at an optimized time.

As discussed above, the platform is also operable to provide for AI-generated or AI-enhanced marketing campaigns 124. In this embodiment, the platform is still operable to receive information from a marketer user device, but, rather than receiving explicitly what is to be included, is operable to include contextual hints, budget information, valid time windows, prompts, and/or other more oblique information to determine the aspects of the AI-campaign. For example, a decision engine 130 is operable to receive sources of brand voice 132 (e.g., plain text descriptions, website, historical data, etc.) in order to make decisions for the campaign via one or more machine learning models 134 for particular aspects of the campaign. For example, the platform is operable to use machine learning models 134 for expanding or contracting the audience of the campaign (or building it entirely from scratch), determining send times for the campaign, generating content for the campaign, and/or other functions based on demographic data 138, event data 136, and/or other sources of data. A quality-checking LLM 140 is operable to review the generated content for the AI-generated or AI-enhanced marketing campaigns 124. Importantly, the platform allows for customizability of which aspects of the campaign are AI-designed or enhanced and which are not. For example, the platform allows for AI-enhancement of the audience but exclusion of AI from the send times for the campaign.

In one embodiment, the platform is operable to facilitate an artificial intelligence-based concierge 126 operable to respond to messages from a contact user device in response to messages as part of a marketing journey or campaign. The AI-based concierge 126 is operable to identify intent of a contact based on a message received from the contact user device, such as if the contact is intending to ask a question, gather information, etc., and automatically respond with a tailored message. The concierge 126 is then operable to leverage the message to attempt to convert the subscriber by emphasizing products, product attributes, sales/offers/discounts, resolving questions, etc. This allows for automated, on-brand responses and engagement, as well as additional data gathering, without requiring human agents for each customer. The platform also provides for artificial intelligence-based website or app augmentation 128, wherein the system is operable to dynamically adjust a link landing page using the decision engine 130 and ML models 134. In one embodiment, the system is operable to generate a personalized sign-up or pop-up unit or page for websites to match a particular campaign or overall brand voice for a company. In one embodiment, the customized sign-up or pop-up unit for the website includes a custom image, a particularized discount offering, a customized headline, and/or one or more other customized features.

In one embodiment, the concierge 126 is operable to engage in preference collection, allowing the concierge 126 to interact with the subscriber or contact to collect and store subscriber data, which is operable to be used to inform and update the machine learning module of the concierge 126 and/or other aspects of the artificial intelligence module of the platform.

One of ordinary skill in the art will understand that the present invention is operable to be used to manage campaigns and journeys that are primarily based on email communication, as well as based on text messages (e.g., Short Message Service (SMS), Multimedia Messaging Service (MMS)) or other forms of communication. For example, whereas the concierge above is discussed with reference to quick response in a text message format, the present invention also contemplates the concierge interpreting and automatically responding to emails sent by a contact user device in response to a marketing campaign email. In another example, the present invention is operable to send messages through over-the-top (OTT) messaging in other applications such as WHATSAPP, FACEBOOK MESSENGER, etc. Alternatively, the present invention is operable to be utilized in other applications and/or websites.

The system is operable to utilize a plurality of learning techniques, including, but not limited to, machine learning (ML), artificial intelligence (AI), deep learning (DL), neural networks (NNs), artificial neural networks (ANNs), support vector machines (SVMs), Markov decision process (MDP), transformers, and/or natural language processing (NLP). The system is operable to use any of the aforementioned learning techniques alone or in combination.

Further, the system is operable to utilize predictive analytics techniques including, but not limited to, machine learning (ML), artificial intelligence (AI), neural networks (NNs) (e.g., long short-term memory (LSTM) neural networks), large language models (LLMs), deep learning, historical data, and/or data mining to make future predictions and/or models. The system is preferably operable to recommend and/or perform actions based on historical data, external data sources, ML, AI, NNs, and/or other learning techniques. The system is operable to utilize predictive modeling and/or optimization algorithms, including, but not limited to, heuristic algorithms, particle swarm optimization, genetic algorithms, technical analysis descriptors, combinatorial algorithms, quantum optimization algorithms, iterative methods, deep learning techniques, and/or feature selection techniques.

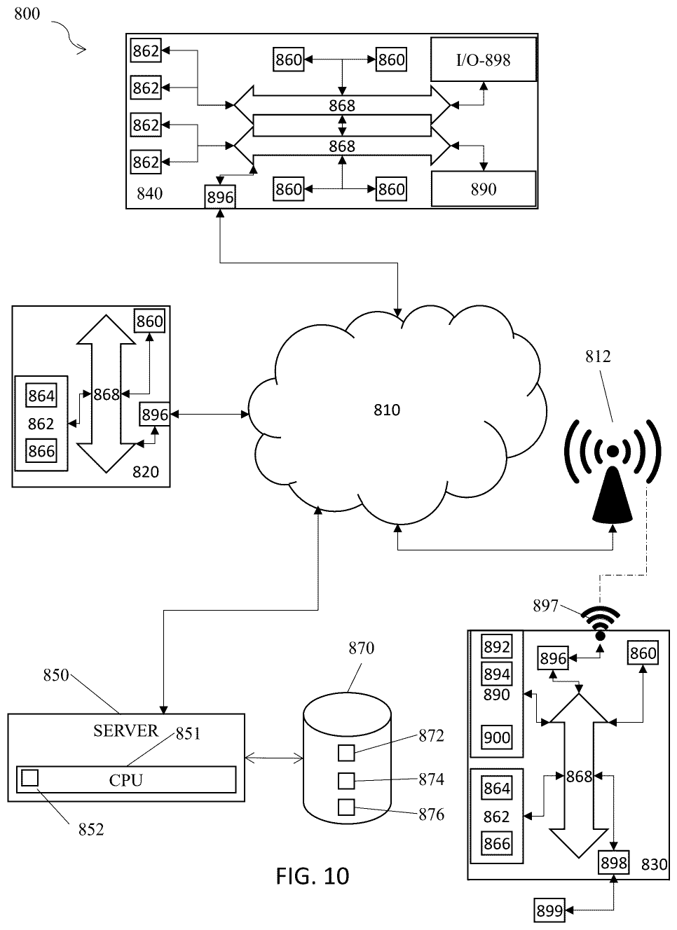

FIG. 10 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 10, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 10, is operable to include other components that are not explicitly shown in FIG. 10, or is operable to utilize an architecture completely different than that shown in FIG. 10. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for enhancing a targeted marketing campaign, comprising:
at least one server platform, including at least one computer processor and a memory, in network communication with at least one user device; and
at least one quality checking large language model (LLM);
wherein the at least one server platform includes an artificial intelligence (AI) module;
wherein the AI module is operable to automatically generate at least one marketing campaign based on input from the at least one user device;
wherein the at least one marketing campaign includes a target audience, optimal send time, and brand voice matching;
wherein the at least one quality checking LLM is operable to review the at least one marketing campaign via natural language processing for accuracy of the target audience, the optimal send time, and the brand voice matching relative to the input from the at least one user device; and
wherein the at least one quality checking LLM is operable to provide a quality score for the at least one marketing campaign.

2. The system of claim 1, wherein the AI module determines the target audience based on website clicks, purchase data, opt-out rate, and/or site visits, and wherein the AI module is operable to predict likelihood of purchase, likelihood to click, and opt-out probability based on the target audience.

3. The system of claim 1, wherein the at least one server platform is operable to utilize a machine learning module to automatically determine an opt-out propensity threshold, wherein the opt-out propensity threshold indicates a probabilistic likelihood that a message in the at least one marketing campaign is likely to cause an opt-out.

4. The system of claim 1, wherein the input includes a text description of the at least one marketing campaign, campaign tools, products and/or services being sold, and/or other information relating to the at least one marketing campaign.

5. The system of claim 1, wherein the at least one user device includes a graphical user interface (GUI), wherein the at least one server platform is operable to display the at least one marketing campaign via the GUI.

6. The system of claim 1, wherein the at least one marketing campaign includes text, images, videos, hyperlinks, and/or any other message.

7. The system of claim 1, wherein the AI module is operable to optimize the target audience via consumer data, demographic data, and/or behavioral data, wherein the consumer data includes time since last purchase, time since last click, time since joining a subscriber list, time since last view, time since item added to a cart, and/or views within a predetermined time period, wherein the demographic data includes age, gender, and/or location, and wherein the behavioral data includes unused offers, propensity to buy, product details page (PDP) pages visited, current purchases, past purchases across one or more brands, and/or previous opt-outs and opt-out triggers.

8. The system of claim 1, wherein the optimal send time is based on a common web page viewing time for each contact.

9. The system of claim 1, wherein the AI module is trained using exploratory sends and/or historical data, wherein the exploratory sends include sending marketing messages at various times and validating clickthrough and purchases, and wherein the AI module is operable to use the exploratory sends and/or the historical data to determine send time optimization.

10. A method for enhancing a targeted marketing campaign, comprising:
providing at least one server platform, including at least one computer processor and a memory, in network communication with at least one user device;
providing at least one quality checking large language model (LLM);
integrating an artificial intelligence (AI) module into the at least one server platform;
the at least one server platform receiving an input from the at least one user device;
generating by the AI module at least one marketing campaign based on the input from the at least one user device;
wherein the at least one marketing campaign includes a target audience, optimal send time, and brand voice matching;
reviewing by the at least one quality checking LLM the at least one marketing campaign via natural language processing for accuracy of the target audience, the optimal send time, and the brand voice matching relative to the input from the at least one user device; and
generating by the at least one quality checking LLM a quality score for the at least one marketing campaign.

11. The method of claim 10, wherein the at least one user device includes a graphical user interface (GUI) and displaying by the at least one server platform a total estimated number of contacts for the at least one marketing campaign, a total change from an original audience to the target audience, and/or financial statistics via the GUI.

12. The method of claim 10, further comprising verifying by the brand voice matching tone, punctuation, and writing style of the at least one marketing campaign.

13. The method of claim 10, further comprising ensuring legal compliance by the quality checking LLM with a marketing legal restriction.

14. The method of claim 10, wherein the AI module is operable to generate 0% egregious content.

15. The method of claim 10, wherein the at least one marketing campaign includes a message, wherein the message includes a trigger-based message.

16. A system for enhancing a targeted marketing campaign, comprising:
at least one server platform, including at least one computer processor and a memory, in network communication with at least one user device;
at least one quality checking large language model (LLM); and
at least one artificial intelligence (AI) concierge;
wherein the at least one server platform includes an AI module;
wherein the AI module is operable to automatically generate at least one marketing campaign based on input from the at least one user device;
wherein the at least one marketing campaign includes a target audience, optimal send time, and a brand voice;
wherein the at least one quality checking LLM is operable to review the at least one marketing campaign via natural language processing for accuracy of the target audience, the optimal send time, and the brand voice relative the input from the at least one user device; and
wherein the at least one AI concierge is operable to automatically respond to feedback received from the at least one user device about the at least one marketing campaign.

17. The system of claim 16, wherein the feedback received from the at least one user device includes complaints, questions, and/or inquiries.

18. The system of claim 16, wherein the at least one AI concierge is operable to automatically respond to the feedback in a manner consistent with the target audience and the brand voice.

19. The system of claim 16, wherein the brand voice includes consistent values, tone, length of response, and/or other qualities.

20. The system of claim 16, wherein the at least one AI concierge is operable to utilize contact specific data to generate the automatic response.
